(19) United States
(12) Patent Application Publication
(10) Pub. No.: US 2026/0188662 A1
(43) Pub. Date: Jul. 2, 2026

(54) ALUMINIUM-BASED RECHARGEABLE BATTERY

(71) Applicant: Eqonic Group Limited, London, Greater London (GB)

(72) Inventors: Jaswir Kandola, London, Greater London (GB); Jeff Rao, London, Greater London (GB); Adrianus Indrat Aria, London, Greater London (GB); Susan A. Impey, London, Greater London (GB); Saerom Jang, London, Greater London (GB)

(73) Assignee: Eqonic Group Limited, London, Greater London (GB)

(21) Appl. No.: 19/130,102

(22) PCT Filed: Nov. 14, 2023
(86) PCT No.: PCT/GB2023/052969

§ 371 Date: May 14, 2025

(30) Foreign Application Priority Data
Nov. 14, 2022 (GB) 2216952.8

(51) Int. Cl. H01M 4/46; H01M 4/02; H01M 4/36; H01M 4/48; H01M 4/58; H01M 4/62; H01M 4/66; H01M 10/054; H01M 10/0565; H01M 10/058; H01M 10/42

(52) U.S. Cl. CPC H01M 4/463; H01M 4/364; H01M 4/366; H01M 4/483; H01M 4/5815; H01M 4/625; H01M 4/669; H01M 10/054; H01M 10/0565; H01M 10/058; H01M 10/4235; H01M 2004/021; H01M 2004/027; H01M 2004/028; H01M 2300/0082

(57) ABSTRACT

The present application relates to a battery and a method for manufacturing the battery. The battery includes an anode comprising aluminium or aluminium alloy, a cathode comprising a transition metal dichalcogenide of the formula MX2 and a transition metal oxide of the formula M′O_{z}; wherein:—O is oxygen;—M and M′ are each independently a transition metal selected from the group consisting of Ti (titanium), V (vanadium), Zr (zirconium), Nb (niobium), Mo (molybdenum), Sn (tin), Hf (hafnium), Ta (Tantalum), W (tungsten) or combinations thereof;—X is selected from S (sulphur), Se (selenium), Te (tellurium) and combinations thereof; and—z is 1, 2 or 3; and an electrolyte comprising ionic aluminium, wherein the electrolyte is disposed between the anode and the cathode.

### FIELD OF THE INVENTION

This invention relates to rechargeable batteries, more particularly to non-lithium rechargeable batteries, to the manufacture of such batteries, and to their uses in electronic devices, energy storage units, and electric vehicles, among others.

### BACKGROUND

Secondary (rechargeable) batteries are used for energy storage and as a power source in numerous commercial and industrial applications, including consumer electronics, residential and commercial buildings, and electric vehicles. Li-ion batteries are currently the most widely used type of secondary battery. These include NMC (lithium nickel manganese cobalt oxide), NCA (lithium nickel cobalt aluminium oxide), LMO (lithium manganese oxide), LFP (lithium iron phosphate), LCO (lithium cobalt oxide), LTO (lithium titanium oxide), Li—Si (lithium silicon), Li—S (lithium sulphur), and Li-air. However, lithium demand will soon outstrip supply to meet worldwide demand.

Despite their wide utility, there are several problems associated with Li-ion batteries. For example, Li anodes are susceptible to dendrite formation which can short-circuit the battery. Moreover, Li-ion batteries that use liquid electrolytes are prone to leakage and/or evaporation of the electrolyte which shortens their lifespan. Also, the organic solvents used in the liquid electrolyte are flammable and vulnerable to thermal runaway, which poses a health and safety risk.

Solid-state electrolytes are one possible means of addressing some of the problems associated with using liquid electrolytes in lithium batteries. However, solid-state batteries such as Li-Si and Li-S have fewer recharge cycles over their lifespan than liquid electrolyte equivalents. This is primarily due to a passivation layer that forms at the solid electrolyte-electrode interface which increases the battery's internal resistance. In addition, large volumetric changes in the solid electrolyte can occur during charge-discharge cycles and lead to fracture, loss of materials, and premature dissolution of the active electrode materials.

Therefore, alternative battery technologies are required which can overcome the above problems at least to some extent.

### SUMMARY OF THE INVENTION

In accordance with a first aspect of the invention, there is provided a battery comprising:
an anode comprising aluminium or aluminium alloy;
a cathode comprising a transition metal dichalcogenide of the formula MX₂, a transition metal oxide of the formula M′O_{z}, or combinations thereof;
wherein:
   O is oxygen;
   M and M′ are each independently a transition metal selected from the group consisting of Ti (titanium), V (vanadium), Zr (zirconium), Nb (niobium), Mo (molybdenum), Sn (tin), Hf (hafnium), Ta (tantalum), and W (tungsten);
   X is selected from S (sulphur), Se (selenium), Te (tellurium) and combinations thereof; and
   z is 1, 2 or 3; and
      an electrolyte comprising ionic aluminium, wherein the electrolyte is disposed between the anode and the cathode.

The battery of the first aspect provides an advantageous alternative to Li-ion batteries by using aluminium metal which is more abundant than lithium, is inexpensive to produce, eco-friendly, recyclable, and due to its three-electron redox reaction, can provide a fast charging, high-capacity battery which can be used in energetically demanding applications such as electric vehicles and large-scale energy storage. Moreover, compared with those of lithium, sodium, potassium, magnesium, calcium, and zinc, aluminium batteries possess the advantage of high theoretical volumetric capacity, offering greater energy storage per unit volume. Furthermore, the use of aluminium, rather than lithium, in a rechargeable battery circumvents the problem of cell degradation associated with lithium dendrite formation (typically seen in other battery systems) since aluminium is not prone to forming dendrites on anodes.

These cathode materials provide improved reaction rates, larger energy densities, and better cycling performances over existing cathode materials, largely due to their having decreased ion diffusion.

The cathode may comprise a transition metal dichalcogenide of the formula MX₂ and a transition metal oxide of the formula M′O_{z}.

Combinations of these materials may eliminate the need to provide a coating as a synthetic interface between the cathode and solid-state electrolyte. Furthermore, the combination of MX₂ and M′O_{z} may enhance the energy capacity of the cathode to a greater extent than may be achievable by either MX2 or MO_{z} alone. The MX₂ and M′O_{z} may therefore produce a synergistic effect when used in combination.

The electrolyte may be a solid or a liquid electrolyte. Where the electrolyte is a solid, the electrolyte may comprise a polymer, a ceramic, or a polymer-ceramic composite. Since solid-state electrolytes tend to have higher energy densities than liquid electrolytes, the inclusion of a solid-state aluminium electrolyte in the battery may increase the speed at which the battery can be charged. It also obviates the use of flammable organic solvents.

The polymer may be selected from the group consisting of polyacrylonitrile, polyvinylidene fluoride, polyethylene oxide, polymethylmethacrylate, polytetrafluoroethylene, polydimethylsiloxane, polyacrylonitrile, polytrimethylene carbonate, polyvinyl alcohol, polyvinyl acetate, polyvinyl pyrrolidone, polysaccharide, and combinations thereof. The polymer may comprise polyacrylate or polymethylmethacrylate. In some embodiments, the polymer may comprise polydiacrylate.

The polymer provides a matrix in which the ionic aluminium (or aluminium salt) is dispersed and through which the charge travels between the electrodes.

M and M′ may each independently be selected from W, Ti and V.

The cathode may further comprise a carbonaceous material selected from the group consisting of graphene, graphene oxide, reduced graphene oxide, graphite, activated carbon, carbon black and combinations thereof, preferably wherein the carbonaceous material is present in the cathode in one or more layers.

Such materials have a broad range of operational voltage, a long-life, are stable and have excellent charge/discharge capabilities.

The cathode may comprise (i) one or more layers of MX₂ and/or M′O_{z}, and (ii) one or more layers of the carbonaceous material. In some embodiments, the cathode may comprise one or more layers of MX₂ and M′O_{z} and optionally one or more layers of the carbonaceous material. The mass ratio of MX₂:M′O_{z} may be from 0.1-3:3-0.1, from 0.5-1.5:1.5-0.5, or about 1:1.

At least a portion of the cathode material may be in the form of a foam, nanoplatelet, or nanotube.

The aluminium or aluminium alloy of the anode may be present in one or more layers, preferably wherein the one or more layers comprise a foam, a nanoparticle, or a nanowire of the aluminium or aluminium alloy.

The aluminium or aluminium alloy of the anode may be at least partially coated with a passivation coating. The passivation coating may comprise an inorganic aluminium compound selected from the group consisting of aluminium phosphate, aluminium molybdate, aluminium tungstate, aluminium vanadate, aluminium oxide, Al-hydroxyquinoline, Al-acetylacetone, Al-diketone, and combinations thereof.

The cathode may additionally comprise a doping agent, which may include gallium (Ga) or germanium (Ge).

In accordance with a second aspect of this invention, there is provided a use of the battery as defined above in a mobile electronic device, a static energy storage device, an uninterruptible power supply, a watercraft, a drone, an electric vehicle, or an aircraft.

In accordance with a third aspect of this invention, there is provided a mobile electronic device, a static energy storage device, an uninterruptible power supply, a watercraft, a drone, an electric vehicle, or an aircraft comprising a battery as defined above.

In accordance with a fourth aspect of this invention, there is provided a method of manufacturing a solid electrolyte for a battery, the method comprising dispersing ionic aluminium in a polymer to provide the solid electrolyte.

The dispersing may comprise forming a solution or mixture comprising the ionic aluminium (or aluminium salt) and a monomer or a precursor of the polymer, preferably a monomer, in a solvent, polymerising the monomer or pre-polymer, and removing the solvent.

The polymer may be molten, and the method may comprise dispersing the ionic aluminium in the molten polymer.

The method may further comprise activating the solid electrolyte. The activating may be performed by chemical, heat, or photoinitiation (e.g. UV radiation).

In accordance with a fifth aspect of this invention, there is provided a method of manufacturing a battery, the method comprising:
providing an anode comprising aluminium or aluminium alloy;
providing a cathode comprising a transition metal dichalcogenide of the formula MX₂, a transition metal oxide of the formula M′O_{z}, or combinations thereof; wherein:
   O is oxygen;
   M and M′ are each independently a transition metal selected from the group consisting of Ti (titanium), V (vanadium), Zr (zirconium), Nb (niobium), Mo (molybdenum), Sn (tin), Hf (hafnium), Ta (Tantalum), W (tungsten) or combinations thereof;
   X is selected from S (sulphur), Se (selenium), Te (tellurium) and combinations thereof; and
   z is 1, 2 or 3;
providing an electrolyte comprising ionic aluminium; and
disposing the electrolyte between and in electrical communication with the anode and the cathode to provide the battery.

The ionic aluminium, or aluminium salt, may comprise aluminium halide, such as aluminium bromide, aluminium chloride, aluminium fluoride and combinations thereof. The aluminium salt may be aluminium chloride.

The cathode may comprise a transition metal dichalcogenide of the formula MX₂ and a transition metal oxide of the formula M′O_{z}. In some embodiments, the cathode may comprise one or more layers of MX₂ and M′O_{z} and optionally one or more layers of the carbonaceous material. 0.1-3:3-0.1, from 0.5-1.5:1.5-0.5, or about 1:1.

The electrolyte may be a solid electrolyte. The solid electrolyte may comprise polyacrylate or polymethylmethacrylate.

Unless otherwise stated, each of the integers described may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims. In addition, all terms, unless specifically defined herein, are intended to be given their commonly understood meaning in the art.

As used herein and in the accompanying claims, unless the context requires otherwise, “comprise” or variations such as “comprises” or “comprising” will be understood to imply the inclusion of a stated integer or group of integers but not the exclusion of any other integer or group of integers.

The term “consist(s)/(ing) essentially of”, with respect to the components of a composition, alloy or mixture, means the composition, alloy or mixture contains the indicated components and may contain minor additional components in an amount less than 1 wt % based on the total weight of the composition, alloy or mixture, and provided that the additional components do not substantially alter the reactivity of the composition, alloy or mixture.

Further, in the discussion of the invention, unless stated to the contrary, the disclosure of alternative values for the upper or lower limit of the permitted range of a parameter, is to be construed as an implied statement that each intermediate value of said parameter, lying between the smaller and greater of the alternatives, is itself also disclosed as a possible value for the parameter.

In addition, unless otherwise stated, all numerical values appearing in this application are to be understood as being modified by the term “about”. As used herein, the term “about” means that the stated value can vary by ±10%. For example, about 90 wt % means 90±9 wt %, and about 0.1 wt % means 0.1±0.01 wt %. When used with reference to a range, the term “about” applies to all values in the range.

The term “ionic aluminium” will be understood to refer to aluminium which is in an ionic state, preferably a positively charged state, e.g. Al¹⁺, Al²⁺, Al³⁺, often Al³⁺. “Ionic aluminium” can also be referred to as “aluminium-containing cations”.

In order that the invention may be more readily understood, it will be described further with reference to the figures and to the specific examples hereinafter.

### BRIEF DESCRIPTION OF THE FIGURES

In the accompanying Figures:

FIG. 1 is a scanning electron micrograph and elemental composition table of nanoplatelets of cathode material comprising a combination of WO₃ and WS₂ (43% WO₃, 57% WS₂) according to the present disclosure, which has been synthesised by magnetron sputtering vapour deposition directly on a metal current collector.

FIG. 2 is a Raman spectrum of the cathode material of FIG. 1.

FIG. 3 is a scanning electron micrograph and elemental composition table of nanoplatelets of cathode material comprising a combination of WO₃ and WS₂ according to the present disclosure, which have been synthesised by magnetron sputtering vapour deposition directly on a metal current collector.

FIG. 4 is a scanning electron micrograph and elemental composition table of nanoplatelets of cathode material comprising a combination of WO₃ and WS₂, according to the present disclosure, which have been synthesised by magnetron sputtering vapour deposition directly on a metal current collector.

FIG. 5 is a scanning electron micrograph and elemental composition table of nanoplatelets of cathode material comprising WS₂ (active material), PVDF (binder), and carbon black (CB) in a mass ratio of WS₂:PVDF:CB of 8:1:1.

FIG. 6 is a Raman spectrum of a liquid electrolyte which confirms the ion species present in the liquid electrolyte of Example 1. Raman peaks at 311 cm⁻¹ and 347 cm⁻¹ correspond to Al₂Cl₇⁻ and AlCl₄⁻, respectively.

FIG. 7 is a graph showing 1 hour-charging-discharging behaviour of a cell comprising a graphite cathode on a metal substrate, a liquid electrolyte synthesised according to the process in Example 1 and comprising the ion species of FIG. 6, and an aluminium anode.

FIG. 8 is a cyclic voltammogram of cells with a graphite cathode material obtained using a scan rate of 0.5 mV/s for 5 cycles from 0 to 1.8 V.

FIG. 9 shows the symmetric plating and stripping behaviour of the symmetrical cell assembled according to the method described in Example 9.

FIG. 10 is a chronoamperometry plot at 10 mV used to confirm initial current and steady-state current to obtain transference number of the liquid electrolyte synthesised by a method described in Example 1. The transference number is 0.25.

FIG. 11 shows a cyclic voltammogram of a cell according to FIG. 7 comprising graphite, liquid electrolyte, and an aluminium anode. The cyclic voltammetry was conducted by applying voltage from 0 V to 2.5 V, using a scan rate of 0.5 mV/s. An onset potential of 1.7 V is observed.

FIG. 12 is a charge-discharge graph at a 1-hour charge (1 C)—1-hour-discharge (1D). A cut-off potential of 1.7 V was set, with specific capacity of 38 mA/g, 34 mA/g, and 29 mA/g at 25 mA/g, 40 mA/g-1C/65 mA/g-1 D, 50 mA/g, respectively. The cell comprises a cathode (commercially available graphite on the metal substrate), liquid electrolyte, and aluminium anode.

FIG. 13 is a scanning electron micrograph of WS₂ and WO₃ deposited by magnetron sputtering and its composition acquired by EDS. The atomic ratio of sulphur to oxygen is 27.75:23.11. Copper (Cu) is a substrate.

FIG. 14 is a cyclic voltammogram of the cell that includes a cathode according to FIG. 13, liquid electrolyte, and aluminium anode obtained using a scan rate of 0.5 mV/s, from 0 to +1.4 V.

FIG. 15 is a charge-discharge graph at 1-hour charge (1 C)—1-hour-discharge (1D). The cut-off potential of 1.2 V was set, with specific capacity of 15 mAh/g, 15.2 mAh/g, 26.5 mAh/g, and 58.1 mA/g at 15 mA/g, 30 mA/g, 70 mA/g, and 140 mA/g respectively. The cell comprises a cathode (WS₂/WO₃ cathode active material on metal current collector according to FIG. 13), liquid electrolyte, and aluminium anode.

FIG. 16 is a cyclic voltammogram of the cell that comprises a cathode (according to FIG. 13), liquid electrolyte, and aluminium anode obtained using a scan rate of 0.5 mV/s, from 0 to +1.8 V.

FIG. 17 is a charge-discharge graph at 1-hour charge (1 C)—1-hour discharge (1D). Cut-off potential of 1.8 V was set, specific capacity of 10 mAh/g, 20.5 mAh/g, 14 mAh/g, and 6 mA/g at 15 mA/g, 25 mA/g, 30 mA/g, and 75 mA/g, respectively. The cell comprises a cathode (WS₂/WO₃ cathode active material on metal current collector according to FIG. 1), liquid electrolyte, and aluminium anode.

FIG. 18 is a graph illustrating the coulombic efficiency of the cell of FIGS. 16, 17 at a charge-discharge current density of 25 mA/g for 20 cycles.

FIG. 19 is an electrochemical impedance spectrum result from an electrolyte of an aluminium salt and a mixture of polyethylene oxide polymers with two different molar weights ranging from 800 to 400,000, with the concentration ranging from 0.1 wt % to 50 wt %. The absence of capacitance behaviour at low frequencies is evidence of total removal of solvent from the solid electrolyte.

FIG. 20 is an electrochemical impedance spectrum of a solid-state free-standing electrolyte synthesised with PEO with different molar weights and Al salt. The negative inductance loop seen at low frequency confirms that there is residual solvent within the electrolyte (FIG. 20). After full removal of the solvent, the inductance loop no longer presents, as shown in FIG. 19.

FIG. 21 is a graph illustrating a cycle life study result of Al anode using the symmetrical cell described in Example 8. The cycle life study was conducted using the current density of 0.0025 mA/cm\hat{ }−2 under 1 hour-charging and 1-hour-discharging (1 C/1 D) for 45 cycles (A), followed by the 30-minute-charge and 30-minute-discharge (2 C/2 D) for 135 cycles (B), without failure. The anode exhibits stable behaviour. The same cell is used to continue studying the cycle life and behaviour of the Al anode can be seen in FIG. 22.

FIG. 22 is a graph illustrating a cycle life study result of the Al anode using the symmetrical cell described in Example 8. The cycle life study was conducted using the current density of 0.005 mA/cm\hat{ }−2 for 110 cycles at 60 degrees C., without failure. The same cell is used to continue studying cycle life and behaviour of the Al anode (can be seen in FIG. 23).

FIG. 23 is a graph illustrating a cycle life study result of the Al anode using the symmetrical cell described in Example 8. The cycle life study was conducted using the current density of 0.0225 mA/cm\hat{ }−2 for 131 cycles at 60 degrees C., without failure. The same cell is used to continue studying the cycle life and behaviour of the Al anode (can be seen in FIG. 24).

FIG. 24 is a graph illustrating a cycle life study result of the Al anode using the symmetrical cell described in Example 8. The cycle life study was conducted at 60 degrees C. using the current density of 1 mA/cm\hat{ }2 under the charging-discharging condition of 800 C for 1375 cycles, without failure.

FIG. 25 is a table showing the reagents and their relative ratios used to manufacture a solid-state electrolyte according to the present disclosure. Mixture A is dissolved in a solvent until homogeneous and mixed with Mixture B, stirred and heated to remove residual solvent, followed by dispersing on a substrate to cure under ambient atmosphere for 24 hours.

FIG. 26 is a table showing the ionic conductivity of solid-state PEO and PVA electrolytes after the complete removal of the polar protic solvents in which they were synthesised.

FIG. 27 is a graph illustrating a cycle life analysis of unpolished Al anode using the symmetrical cell described in Example 8. The cycle life study was conducted at 60 degrees C. using a current density of 0.0025 mA/cm\hat{ }2 under 1-hour-charging—1 hour discharging for 98 cycles (196 hours). The unpolished Al anode exhibits unstable behaviour unlike the polished Al anode in FIGS. 22, 23, 24, and 25.

FIG. 28 is a scanning electron micrograph of cathode material comprising WS₂ (active material), PVDF (binder), and carbon black (CB) in a mass ratio of WS₂:PVDF:CB of 7:1.5:1.5, described in Example 11.

FIG. 29 is a graph illustrating a comparison of cycle life study between polished anode and anode with no polish, using the symmetrical cell described in Example 13. The unpolished Al anode exhibits far higher resistance than the polished Al anode.

FIG. 30 is a white light interferometry image of as received aluminium foil surface.

FIG. 31 is a white light interferometry image of surface treated aluminium foil surface.

FIG. 32 is a picture of a molybdenum foil showing difference in colour and reflectance between as received surface of Mo foil and anodised surface of the foil with a method described in Example 17.

FIG. 33 is an EDS elemental analysis result of anodised molybdenum foil which was prepared according to the method described in Example 17. The elemental analysis result shows a higher oxygen content of the anodised surface (FIG. 32, Right-side of the image) vs the untreated surface (FIG. 32, left-side of the image).

FIG. 34 is a Raman spectrum of anodised molybdenum surface.

FIG. 35 is a scanning electron micrograph of cathode material comprising TiO2 (active material), PVDF (binder), and carbon black (CB) in a mass ratio of TiO2:PVDF:CB of 7:1.5:1.5, described in Example 19.

FIG. 36 is a scanning electron micrograph of cathode material comprising WS2 (active material), PVDF (binder), and carbon black (CB) in a mass ratio of TiO2:PVDF:CB of 7:1.5:1.5, described in Example 19.

FIG. 37 is a scanning electron micrograph of cathode material comprising WS2 and TiO2 (active material), PVDF (binder), and carbon black (CB) in a mass ratio of WS2+TiO2:PVDF:CB of 7:1.5:1.5, described in Example 19. The mass ratio between WS2 and TiO2 was 1 to 1.

FIG. 38 is X-ray diffractogram of raw materials (WS2 and TiO2 powder), and synthesised cathode materials.

FIG. 39 is a charge-discharge graph at a 1-hour charge (1 C)—1-hour discharge (1D) with constant current (CC)—constant voltage (CV) charge at 2.0 V using current density of 5 mA/g. The specific capacities of 1.3 mAh/g, 20.5 mAh/g, 4.5 mAh/g, and 4.9 mA/g for TiO2+CB+PVDF slurry, WS2+CB+PVDF slurry, and WS2+TiO2+CB+PVDF slurry, respectively. The cell comprises a cathode (TiO2+CB+PVDF slurry, WS2+CB+PVDF slurry, or WS2+TiO2+CB+PVDF slurry as described in Example 19), liquid electrolyte (Example 10), and aluminium anode.

FIG. 40 is a charge-discharge graph at a 1-hour charge (1 C)—1-hour discharge (1D) with constant current (CC)—constant voltage (CV) charge at 2.0 V using current density of 25 mA/g. The specific capacities of 25.3 mAh/g, 20.5 mAh/g, 4 mAh/g, and 5.4 mA/g TiO2+CB+PVDF slurry, WS2+CB+PVDF slurry, and WS2+TiO2+CB+PVDF slurry, respectively. The cell comprises a cathode (TiO2+CB+PVDF slurry, WS2+CB+PVDF slurry, or WS2+TiO2+CB+PVDF slurry as described in Example 19), liquid electrolyte (Example 10), and aluminium anode.

FIG. 41 is a charge-discharge graph at a 1-hour charge (1 C)—1-hour discharge (1D) with constant current (CC)—constant voltage (CV) charge at 2.0 V using current density of 50 mA/g. The specific capacities of 12.5 mAh/g, 3.5 mAh/g and 5.2 mAh/g from TiO2+CB+PVDF slurry, WS2+CB+PVDF slurry, and WS2+TiO2+CB+PVDF slurry, respectively. The cell comprises a cathode (TiO2+CB+PVDF slurry, WS2+CB+PVDF slurry, or WS2+TiO2+CB+PVDF slurry as described in Example 19), liquid electrolyte (Example 10), and aluminium anode.

FIG. 42 is a charge-discharge graph at a 1-hour charge (1 C)—1-hour discharge (1D) with constant current (CC) using current density of 25 mA/g. The specific capacities of 14.8 mAh/g, 6.8 mAh/g for the cell comprises a cathode of TiO2+CB+PVDF slurry and WS2+TiO2+CB+PVDF slurry, respectively.

FIG. 43 is a charge-discharge graph at a 1-hour charge (1 C)—1-hour discharge (1D) with constant current (CC)—constant voltage (CV) charge at 2.3 V using current density of 25 mA/g. The specific capacity of 6.3 mAh/g was observed. The cell comprises a cathode (WS2+CB+PVDF prepared by a method as described in Example 19), liquid electrolyte (Example 10), and aluminium anode.

FIG. 44 is a charge-discharge graph at an hour charge—1 hour discharge using constant current density (0.01 mA/cm\hat{ }2). The cut-off voltage was set to 2.5 V and 0 V).

FIG. 45 is a table showing surface treatment and corresponding surface roughness parameters and electron and ionic transport behaviour from EIS fitting.

### DETAILED DESCRIPTION OF THE INVENTION

The present disclosure provides a battery, and in particular a rechargeable or secondary battery, that has enhanced performance in terms of charge-discharge rates, cycling stability, rate capability and lifespan over lithium-ion batteries.

The battery includes an anode comprising aluminium or aluminium alloy, a cathode, and an electrolyte comprising ionic aluminium (typically in the form of an aluminium salt). The electrolyte is disposed between the anode and the cathode and is configured to permit reversible deposition and dissolution of aluminium at the anode and reversible intercalation and de-intercalation of anions at the cathode in use, and/or alloying/dealloying and/or conversion/deconversion of ionic aluminium species.

The cathode may comprise a transition metal dichalcogenide of the formula MX₂, a transition metal oxide of the formula M′O_{z}, or combinations thereof, wherein:
M and M′ are each independently a transition metal selected from the group consisting of Ti (titanium), V (vanadium), Zr (zirconium), Nb (niobium), Mo (molybdenum), Sn (tin), Hf (hafnium), Ta (Tantalum), W (tungsten), and combinations thereof;
X is selected from S (sulphur), Se (selenium), Te (tellurium) and combinations thereof; and
z is 1, 2 or 3.
In the above battery, each of the anode and the cathode may be in contact and electrical communication with a current collector. The current collector may comprise one or more metals selected from stainless steel 316 (SS316), copper, nickel, and molybdenum, preferably from SS316 and molybdenum, and more preferably molybdenum.

The battery may be for use in a mobile electronic device, a static energy storage device, an uninterruptible power supply, a watercraft, a drone, an electric vehicle, or an aircraft.

The present disclosure further provides a mobile electronic device, a static energy storage device, an uninterruptible power supply, a watercraft, a drone, an electric vehicle, or an aircraft comprising a battery as defined herein.

### Anode

The anode of the above battery may have one or more of the following features.

The aluminium or aluminium alloy of the anode may be present in one or more layers. Each layer may have a depth of from 1 micron to 500 microns, from 1 micron to 250 microns, from 1 micron to 150 microns, from 1 micron to 100 microns, from 1 micron to 50 microns, from 1 micron to 25 microns, from 1 micron to 15 microns, from 1 micron to 10 microns, from 5 microns to 500 microns, from 5 microns to 250 microns, from 5 microns to 150 microns, from 5 microns to 100 microns, from 5 microns to 50 microns, from 5 microns to 25 microns, from 5 microns to 15 microns, from 10 microns to 500 microns, from 10 microns to 250 microns, from 10 microns to 150 microns, from 10 microns to 100 microns, from 10 microns to 50 microns. The layer may be in the form of a foil (having a thickness of from 10 microns to 250 microns, preferably from 10 microns to 50 microns, or from 20 microns to 30 microns), an open cell foam (which may be an architected or stochastic foam), a lattice (such as a gyroid or Kelvin lattice), nanoparticles (which may optionally include a binder and may optionally be at least partially fused), or nanowires (which may have random or aligned orientations).

Open cell foams with submicron pore sizes offer a good balance between ion and electron transport and mechanical durability. Monolithic architected lattices, such as gyroid and Kelvin lattices, with well-defined pore geometry and size distribution, may be preferred to provide isotropic ion and electron transport and mechanical properties across the bulk of the anode. Sub-micron pore size and wall thickness may be preferred to provide the largest specific surface area. The foam can be manufactured by casting on self-assembled block copolymer moulds or by additive manufacturing. Stochastic foams with pore and ligament sizes of tens of microns may be used as scaffolds to provide mechanical stability and may act as current collectors.

The nanoparticles may have sub-50 nm effective diameters and specific surface areas of more than 40 m²/g to offer a good balance between large surface area and ease of manufacture. They may be partially fused or bound together to minimise interparticle contact resistances and reduce the susceptibility to breakage. Partially fused nanoparticles without binders may be preferred and may be obtained by controlled sintering to create contiguous networks that are highly porous, electrically conductive, and mechanically stable. Where the nanoparticles include one or more binders, the binders may be based on polymer matrices with carbon additives. These additives may include carbon black and/or graphitic carbon, such as mono/few/multi-layer graphene, graphene oxide, reduced graphene oxide, or graphite. Monolayer graphene flakes may be preferred due to their superior mechanical and electronic properties. The polymer matrices may include polyacrylonitrile, polyvinylidene fluoride (PVDF), polyethylene oxide, polymethylmethacrylate, polytetrafluoroethylene, polydimethylsiloxane, polyacrylonitrile, polytrimethylene carbonate, polyvinyl alcohol/acetate/pyrrolidone, polysaccharide, and their combinations or derivatives.

The nanowires may have sub-100 nm effective diameters, an aspect ratio of more than 10, and a specific surface area of more than 40 m²/g to provide optimal ionic and electron transport and stable structures. They may be manufactured in high volume by continuous self-assembly bottom-up growth or batch top-down etching. Vertically aligned nanowires embedded on current collectors may be preferred over horizontally aligned alternatives. Bottom-up growth of nanowires may be obtained on pure Al or Al alloy substrates by self-assembly precipitation, chemical vapour deposition (CVD), or templated electroplating. Top-down anodising-etching of bulk pure Al or Al alloys into arrays of vertically aligned nanowires may be obtained using diluted acidic solutions for the anodisation, such as sulfuric acid, and diluted alkaline solutions for etching of the developed oxides, such as sodium hydroxide.

The aluminium or aluminium alloy of the anode may be at least partially coated with a selective passivation coating to enhance uniformity at the electrode-electrolyte interface and to suppress dendrite formation, and/or a conformal passivation coating to promote atomically intimate contact with the electrolyte and allow fast tunnelling of Al³⁺ ions. The passivation coating may comprise an inorganic aluminium compound selected from the group consisting of aluminium phosphate, aluminium molybdate, aluminium tungstate, aluminium vanadate, aluminium oxide, organic Al complex (including, but not limited to, Al-hydroxyquinoline, Al-acetylacetone, and Al-diketone) and combinations thereof.

The use of a liquid phase process to produce a synthetic solid electrolyte interface (SEI) layer may result in an inhomogeneous and non-conformal layer that produces dendrites which cause electrical shorts and thermal runaway. Therefore, to avoid these issues, vapour deposition methods, particularly atomic layer deposition (ALD) and/or molecular layer deposition (MLD), may be used to form the one or more anode layers. The use of vapour deposition methods may result in a homogeneous Al ion flux, thereby avoiding the formation of dendrites, extending the lifespan of the Al anode, and improving safety of the battery.

Further enhancement of the anode material can be achieved by selective etching or electropolishing or mechanical polishing to preferentially remove sites with heterogeneous electrochemical activity, such as asperities, sharp corners, certain crystal grains, and surface impurities and imperfections. These heterogenous sites are susceptible to the formation of dendrites during the charging/discharging process due to heterogenous localised concentration of the electric field. A solution of dilute acid, such as phosphoric acid, or alkaline, such as sodium hydroxide, or deep eutectic solvents, e.g. choline chloride+urea, choline chloride+ethylene glycol, or choline chloride+glycerol, may be used. Surface treatment as used herein may improve wettability through charge (electron) donation and acceptance (Lewis acid-base).

Polishing may serve to reduce the charge transfer resistance and equalise the electric potential within the cell.

The aluminium in the anode may have a purity of >98.5%. The aluminium alloy in the anode may contain silicon in an amount of from 0.6 to 21.5 wt %, such as from 4-6 wt %, and may preferably be a 4000 series Al alloy. The aluminium may be secondary aluminium, i.e. produced from recycled aluminium sources.

The overall thickness of the aluminium/aluminium alloy active anode may be from 1 to 500 μm. The entire anode may be embedded in the solid-state electrolyte to form an anolyte.

### Cathode

The cathode of any of the above batteries may have one or more of the following features.

In the formulas MX₂ of the transition metal dichalcogenide and M′O_{z} of the transition metal oxide, M and M′ may each independently be selected from W, Ti and V, or and/or from Mo, Nb and Sn. The large atomic radii of these metals may serve to space apart layers of the cathode material and enhance the speed of intercalation/de-intercalation, alloying/dealloying, and/or conversion/deconversion of ions into/from the cathode material.

The cathode may further comprise a carbonaceous material selected from the group consisting of graphene, graphene oxide, reduced graphene oxide, graphite, activated carbon, carbon black and combinations thereof. Preferably the carbonaceous material is present in the cathode in one or more layers. Such materials have a broad range of operational voltage, a long-life, are stable and have excellent charge/discharge capabilities. The carbonaceous material may improve electron transport, heat dissipation, and structural integrity of the cathode.

The cathode may comprise (i) one or more layers of MX₂ and/or M′O_{z}, and (ii) one or more layers of the carbonaceous material. The layers may be van der Waals two-dimensional (2D) layers. In some embodiments, the transition metal dichalcogenide may be combined with the transition metal oxide. In other embodiments, the cathode may comprise a transition metal dichalcogenide. The use of combinations of these cathode materials may avoid the need to provide a coating as synthetic interface between the cathode and solid-state electrolyte. Where the cathode comprises a combination of MX₂ and M′O_{z}, a mass ratio of MX₂:M′O_{z} may be from 0.1-3:3-0.1, from 0.5-1.5:1.5-0.5, or about 1:1. A mass ratio of the MX₂ and/or M′O_{z}:carbonaceous material may be from 4-10:0.1-3, from 6-9:0.5-2, or about 7:1.5. In some embodiments, the ratio of the MX₂ and/or M′O_{z}:carbonaceous material may be about 8:1.

The cathode material may be enhanced with additional chalcogen compounds and carbon additives. For example, the cathode may additionally comprise a doping agent, such as gallium (Ga) or germanium (Ge). The van der Waals cathodes may be deposited on a metallic current collector which may be connected to a cell tab lead terminal. The current collector may comprise one or more metals selected from stainless steel 316 (SS316), copper, nickel, and molybdenum, preferably SS316 or Mo, and most preferably Mo. The entire active cathode material, including the MX₂ with or without M′O_{z}, may be embedded in the solid-state electrolyte to form a catholyte.

The charging/discharging processes of the cathode may include intercalation, alloying, or bulk conversion. The 2D van der Waals layers may promote an ionic intercalation mechanism to enable rapid ion transport with only 1D volume change. Non-layered M′O_{z} may promote alloying and conversion mechanisms to allow high capacity with 3D volume change.

To promote rapid ion transport and accommodate large volume change from the uptake and release of ions, the active cathode materials may have a 3D structural geometry with multi-length hierarchical porosity.

The 2D layered cathode material may be synthesised either by a bottom-up or top-down approach. The bottom-up approach may include but not be limited to chemical vapour deposition (CVD), physical vapour deposition (PVD), and thermal solid conversion. The top-down approach may include but not be limited to exfoliation by electrochemical and micromechanical, electrochemical etching in the liquid phase and vapour phase, hydrothermal, solvothermal, and intercalation-dispersion. Micron-scale flakes of the cathode material having a monolayer (or less than 10 layers) may be preferred due to their superior strain compliance properties.

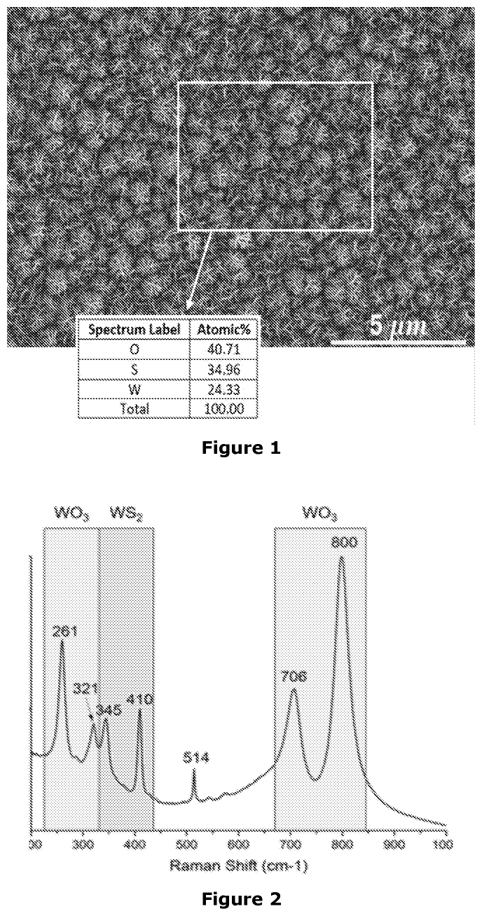

At least a portion of the active cathode material may have a 3D configuration of one or a combination of the following: foams, nanoplatelets (as shown in FIG. 1), and nanotubes. 3D foams provide good ionic transport and mechanical durability as they can accommodate large volume changes. The foam may be manufactured directly on 3D metal current collector foams. Architected lattices, such as gyroid and Kelvin lattices with well-defined pore geometry and size distribution, may be preferred over stochastic foams due to their superior ionic and mechanical properties.

The cathode material may be coated or deposited on a metal current collector foam, for example by vapour deposition such as magnetron sputtering, ALD, MLD, or CVD (chemical vapour deposition).

The MX₂ may be obtained by direct sulphurisation of an M′O_{z} foam using elemental sulphur or thiourea at elevated temperatures.

The cathode material may be manufactured as a 3D nanoplatelet (as shown in FIG. 1). This provides a convenient means of manufacturing the cathode material on a metallic current collector. Conductive binders may be provided to maintain structural integrity and conductivity of the nanoplatelet.

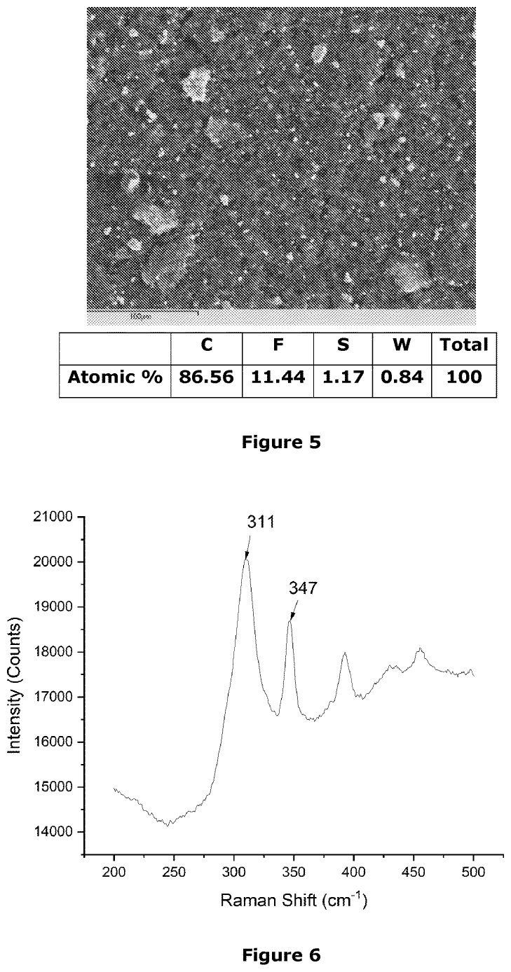

The cathode material may be deposited on the current collector using screen-print, drop-cast, spin-coat, dip-coat, aerosol-spray, inkjet-print, slot-die, doctor-blade, rolling or combination thereof coating methods (result as shown in FIG. 5). The material may be subjected to a liquid phase exfoliation step before coating.

Binders may be provided to mechanically stabilise the cathode material structure and maintain electrically conductive pathways. The binders may comprise polymer matrices with carbon additives such as carbon black, graphitic carbon, mono/few/multi-layer graphene, graphene oxide, reduced graphene oxide, or graphite. The carbon additive may be provided as flakes. Monolayer graphene flakes may be preferred. The polymer matrices may include polyacrylonitrile, polyvinylidene fluoride (PVDF), polyethylene oxide, polymethylmethacrylate, polytetrafluoroethylene, polydimethylsiloxane, polyacrylonitrile, polytrimethylene carbonate, polyvinyl alcohol/acetate/pyrrolidone, polysaccharide, acrylated/methacrylated hydrogel/solvogel and their combinations. In some embodiments, a PVDF binder, optionally in combination with carbon black, may be used. In some embodiments, the polymer matrix may comprise a polymer selected from polyethylene glycol methacrylate (PEGMA), polyethylene glycol diacrylate (PEGDA) (as exemplified in Examples 14-16), polyurethane acrylate (PUA), glucose methacrylate (GlucMA), chitosan methacrylate (ChitMA), gelatin methacrylate (GelMA), their derivatives and their co-polymers. For example, the polymer may comprise PEGDA. A mass ratio of MX₂ and/or M′O_{z}:polymer:carbonaceous material in the cathode may be from 4-10:0.1-3:0.1-3, from 6-9:0.5-2:0.5-2, or preferably about 7:1.5:1.5 or about 8:1:1.

Where 2D graphitic carbon flakes are used as the additives, they can be blended directly and deposited simultaneously with the dispersion of exfoliated 2D MX₂ or layered M′O_{z} to form van der Waals heterostructures that improve electron transport from the active materials to the current collectors. 2D graphitic carbon flakes may improve mechanical compliance to accommodate large volume changes during charging and discharging cycles.

Liquid phase exfoliated 2D MX₂ or layered M′O_{z} may also be deposited on transition metal foams and nanowires to create templated 3D structures. Exfoliated cathode material may be dispersed in a volatile organic solvent, which may be subsequently evaporated after the deposition.

Physical vapour deposition (PVD) of MX₂, M′O_{z} or a combination thereof on a metal current collector may be performed by magnetron sputtering, thermal evaporation, or e-beam evaporation. PVD may allow the growth of vertically aligned nanoplatelets without the use of binders.

3D arrays of MX₂ and/or M′O_{z} nanotubes may offer advantageous ionic transport, high strain compliance, and stable structures. Arrays of vertically aligned MX₂ and/or M′O_{z} nanotubes may be preferred over horizontal or randomly oriented arrangements to minimise the tortuosity of ion and electron transport.

Stochastic 3D structures of MX₂, M′Oz, or a combination thereof on M or M′ current collectors may be used to prepare the cathode material. The stochastic 3D structures may be deposited by hydrothermal (water) and/or solvothermal (organic solvent or deep eutectic solvent) processes using elemental chalcogen (such as S, organosulphur, or thiourea). The current collectors may be anodised before deposition of the stochastic 3D structures.

The nanotubes may be obtained by bottom-up growth, by catalytic CVD, or, to obtain nanotubes of MX₂ by direct sulphurisation, carburising, or nitriding of M′O_{z} nanowires at elevated temperatures. This process may involve the use of sulphur, carbon, and nitrogen-containing precursors including but not limited to elemental sulphur, thiourea, hydrocarbon, ammonia, or urea. Alternatively, the nanotubes may be obtained by CVD, ALD, or MLD on metal nanowires using sulphur, carbon, and nitrogen-containing precursors such as elemental sulphur, thiourea, hydrocarbon, ammonia, or urea.

Additional elemental chalcogen (e.g. sulphur (S), selenium (Se), or tellurium (Te)), or chalcogen compounds (e.g. thiourea), may be added into the MX₂ active cathode materials by melting the elemental chalcogen or chalcogen compounds directly onto the active materials to further improve the total amount of active materials. Thin layers of scaffolding materials may subsequently be added to minimise the dissolution of chalcogens from the active cathode materials and suppress the formation of electrochemically inactive polysulphides. These scaffolds may comprise 2D graphitic carbon flakes or conformal aluminium chalcogenides. The 2D graphitic carbon scaffolds may comprise sub-50 nm films of the monolayer, or fewer than ten layers, of graphene or other carbonaceous materials (such as those listed above).

The aluminium chalcogenides may comprise sub-50 nm films or layers of aluminium sulphide (AlSₓ), aluminium selenide (AlSeₓ), aluminium telluride (AlTeₓ), or their combinations, where x is 1 or 2. These chalcogenide scaffolds may be deposited by self-limiting ALD or MLD. The overall thickness of the MX₂ active cathode materials may be from 1 to 500 μm.

### Electrolyte

The electrolyte of any of the above batteries may have one or more of the following features.

Unless otherwise specified, the electrolyte may be a liquid electrolyte or a solid electrolyte. The electrolyte may comprise ionic aluminium, which may be in the form of an aluminium salt. The aluminium salt may be selected from AlCl₃ (aluminium chloride), AlBr₃ (aluminium bromide), AlI₃ (Aluminium iodide), Al(ClO₄)₃ (aluminium perchlorate), Al(BrO₄)₃ (aluminium perbromate), Al₂(CO₃)₃ (aluminium carbonate), Al₂(SO₄)₃ (aluminium sulphate), Al(CH₃CO₂)₃ (aluminium(iii) triacetate), Al(BF₄)₃ (aluminium tetrafluoroborate), Al(PF₆)₃ (aluminium hexafluorophosphate), Al(OTf)₃ (aluminium trifluoromethanesulfonate), aluminium bis(fluorosulfonyl)imide, aluminium bis(trifluoromethanesulfonyl)imide, and their combinations. The salt may comprise an aluminium halide, such as AlCl₃, AlBr₃ or AlI₃, or combinations thereof, and in particular may comprise AlCl₃. In some embodiments, the salt may comprise aluminum trifluoromethanesulfonate Al(OTf)₃.

In an embodiment, the liquid electrolyte may comprise a mixture of the ionic aluminium (or aluminium salt) described above and an ionic liquid. The ionic liquid may comprise imidazolium, pyrrolidinium, ammonium, pyridinium, or phosphonium cations. For example, the ionic liquid may comprise imidazolium aluminates, pyridinium aluminates, fluoropyrazolium aluminates, triazolium aluminates, aralkylammonium aluminates, alkoxyammonium aluminates, aralkylphosphonium aluminates, aralkylsulfonium aluminates, guanidinium aluminates, alkylated derivatives of any of these, and mixtures thereof. A molar ratio of the ionic aluminium (or aluminium salt) to the ionic liquid may be greater than 1:1, greater than 1:2, or greater than 1:3 or within a range defined between any two of these ratios. The electrolyte may have a low water content. For example, the water content may be present in an amount less than 1,000 ppm, 500 ppm, 200 ppm, 100 ppm, or 50 ppm.

In another embodiment, the liquid electrolyte may comprise an aqueous electrolyte comprising a water-containing solvent and the aluminium salt described above. The aqueous electrolyte may contain aluminium ions and optionally sodium ions. The aqueous electrolyte may comprise a gel-like aqueous electrolyte in which an aqueous electrolytic solution and a polymer material are combined. Examples of the polymer material may include polyvinylidene fluoride, polyacrylonitrile, polyethylene oxide, and combinations thereof.

The solid-state electrolyte may be aluminium-ion conductive and may comprise an aluminium-containing solid phase matrix and the ionic aluminium (or aluminium salt) described above. The solid phase matrix may be made of a polymer, a ceramic (inorganic), or a polymer-ceramic composite.

The solid electrolyte comprising the polymer may be manufactured by a method comprising a step of dispersing (i.e. distributing) the ionic aluminium (or aluminium salt) in the polymer. The ionic aluminium may be mixed with molten polymer and dispersed therein. The dispersing may comprise forming a solution or mixture of the ionic aluminium and a monomer or a precursor of the polymer (preferably a monomer) in a solvent, polymerising the monomer or pre-polymer, and removing the solvent to provide the solid electrolyte.

The solid electrolyte may be activated once formed. The activation may be conducted by applying a cyclic voltage from −1.4 V to +1.4 V for a single or multiple cycle(s). For example, for a PVA solid electrolyte, activation may be conducted from −1.4 V to +1.4 V (2.5 mV/s). For a PEO solid electrolyte, activation may be conducted from −2 V to +2 V (at either 2.5 mV/s or 0.1 mV/s). Typically, symmetric solid electrolytes can be activated at either +/−1.4, +/−2 V, or +/−2.5 V and asymmetric solid electrolytes at +/−2 V (0.1 mV/s). For liquid electrolytes, symmetric cells can be activated at +/−1.4 V and asymmetric cells at up to +/−2 V or +/−2.5 V. For a PEGDA solid electrolyte, activation may be conducted from −2.5 V to +2.5 V (0.1 mV/s).

The solid polymeric electrolyte may comprise a uniform dispersion of the aluminium salt described above in a nanoporous amorphous or semi-crystalline polymer. The concentration of Al salt may range from 1 wt % to 60 wt %. The polymer matrices may be of any molecular weight but must have a melting temperature higher than 60° C. The polymer may be selected from the group consisting of polyacrylonitrile, polynitrile, polyvinylidene fluoride, polyethylene oxide (PEO), polyethylene glycol (PEG), polymethylmethacrylate, polytetrafluoroethylene, polydimethylsiloxane, polyacrylonitrile, polytrimethylene carbonate, polyvinyl alcohol (PVA), polyvinyl acetate, polyvinyl pyrrolidone, polysaccharide, acrylated/methacrylated hydrogel/solvogel, and combinations thereof. The polymer may be selected from PVA, PEO, PEG, or a combination thereof (such as PEO/PEG, PVA/PEO or PVA/PEG). The polymer may preferably be selected from polyethylene glycol methacrylate (PEGMA), polyethylene glycol diacrylate (PEGDA) (as exemplified in Examples 14-16), polyurethane acrylate (PUA), glucose methacrylate (GlucMA), chitosan methacrylate (ChitMA), gelatin methacrylate (GelMA), their derivatives and their co-polymers. For example, the polymer may comprise a diacrylate, such as PEGDA. The polymer preferably has high elasticity and plasticity which enhances stability at the electrode interface, and good resistance to volume changes during operation.

The solvent may be an aprotic solvent (such as acetonitrile, acetone, dimethyl sulfoxide (DMSO), N-methyl-2-pyrrolidone (NMP), dimethylformamide (DMF), tetrahydrofuran (THF), dichloromethane, or propylene carbonate (PC), preferably acetonitrile or acetone), or where the monomer is water-soluble (e.g. vinyl alcohol or saccharide), a protic solvent (such as water, methanol, ethanol, propanol, isopropanol, butanol, isobutanol, a C1-C4 alcohol, nitromethane or combinations thereof). For water soluble polymers, such as PVA, water may preferably be used as solvent.

To facilitate ease of removal, the solvent preferably has a high vapour pressure (e.g. greater than 3 hPa, such as from 3 hPa to 600 hPa, at 20° C.) and/or a low boiling point (e.g. less than 100° C. at 100 kPa). The solvent preferably has a relative polarity of greater than 0.302 based on the Reichardt relative polarity index (“Solvents and Solvent Effects in Organic Chemistry,” Christian Reichardt https://onlinelibrary.wiley.com/doi/book/10.1002/9783527632220).

The Al salt may be used without further modification or may be pre-mixed with a eutectic mixture which may be selected from urea and its derivatives (e.g. thiourea, alkylurea, arylurea), alkali halides (e.g. NaCl, KCl, NaBr, KBr), and combinations thereof.

The Al salt may be mixed with the monomer, pre-polymer, or molten polymer directly. Alternatively, the Al salt may first be dissociated by solvation in an ionic liquid, aprotic solvent, or protic solvent (where the monomer is water-soluble) prior to mixing with the monomer, pre-polymer, or molten polymer. The ionic liquid may comprise imidazolium, pyrrolidinium, ammonium, pyridinium, or phosphonium cations. After mixing, polymerisation may be initiated, for example, by radiation (e.g. UV), chemical or temperature initiation. Where the polymer is an acrylated or methacrylated hydrogel/solvogel, a photoinitiator may be present and polymerisation may be initiated by radiation (e.g. UV). The solvent may be removed by heat, vacuum, or both during or after polymerisation.

The solid electrolyte comprising the inorganic (ceramic) may comprise an ion conductive oxide, fluoride, chloride, carbide, or carbonate of aluminium. The ceramic may be selected from AlPOₓ (aluminium phosphate), AlTiPOₓ (aluminium titanium phosphate), AlGePOₓ (aluminium germanium phosphate), Al(FO_{y})ₓ (aluminium oxyfluoride), Al(ClO_{y})ₓ (aluminium oxychloride), Al(BrO_{y})ₓ (aluminium oxybromate), Al₂(CO_{y})ₓ (aluminium carbonate), Al(CH₃CO₂)ₓ (Aluminium triacetate), AlClₓ (aluminium chloride), AlFₓ (aluminium fluoride), AlPₓS_{y} (aluminium phosphosulphide), AlLa_{z}Zr_{y}Oₓ (aluminium lanthanum zirconate), AlCa_{z}Zr_{y}Oₓ (aluminium calcium zirconate), AlCa_{z}Ta_{y}Oₓ (aluminium calcium tantalate), Al(TiO_{y})ₓ (aluminium titanate), Al(SiO_{y})ₓ (aluminium silicate), Al(WO_{y})ₓ (aluminium tungstate) and their combinations and derivatives. The ratio between cation and anion of these compounds can be sub-stoichiometric, stoichiometric, and super-stoichiometric, with 2<x<4, and 0<y<5, and 0<z<2.

The structure of the ceramic may be a 2D layered van der Waals, garnet, perovskite, anti-perovskite, NASICON, sulphide, or zeolite structure. The zeolite may be a microporous aluminosilicate containing Al salts. NASICON refers to a sodium super-ionic conductor, which is a family of ceramic materials which have a chemical formula Na₁₊ₓZr₂SiₓP₃₋ₓO₁₂, 0<x<3.

The polymer-ceramic composite may comprise a polymer (as described above) in which particles of inorganic compounds are dispersed. The inorganic particles may comprise TiO₂, SiO₂, MgO, zeolite, montmorillonite, or combinations thereof.

The polymer-ceramic composite may comprise a composite mixture of Al ion conductive ceramics within Al ion conductive nanoporous polymer matrices. The polymer component may provide mechanical compliance to maintain a conformal interface between cathode and electrode within the catholyte, while the ceramic component provides additional mechanical and thermal stability.

The battery of the present disclosure is manufactured by providing an anode (as described herein), a cathode (as described herein), and an electrolyte (as described herein), and disposing the electrolyte between and in electrical communication with the anode and the cathode to provide the battery.

### Electrode-Electrolyte Interface

The interface between the anode and solid-state electrolyte may be provided by a passivation layer comprising an Al compound to maintain conformal contact between anode and electrolyte, maximise uniformity of surface plating and stripping, prevent dendrite formation, and suppress premature dissolution of active materials. In some embodiments, monolithic polymerisation of solid electrolyte on anode and cathode may ensure intimate contact between the electrolyte and the electrodes.

A sub-50 nm film of the Al compound may be applied to the most electrochemically active sites, e.g. asperities, sharp corners, and certain crystal grains. The thickness of these compounds must not be greater than the effective pore size or diameter of the anode materials. The Al compound may be selected from inorganic aluminium compounds selected from AlPₓO_{y} (aluminium phosphate), AlMoₓO_{y} (aluminium molybdate), AlWₓO_{y} (aluminium tungstate), AlVₓO_{y} (aluminium vanadate), AlOₓ (aluminium oxide), and combinations thereof, where 2<x<4, 0<y<5, or an organic Al complex (e.g. Al-hydroxyquinoline, Al-acetylacetone, and Al-diketone).

Application of this passivation layer may be followed by or substituted by conformal sub-10 nm Al compounds to suppress premature dissolution of active materials and to provide structural scaffolding. Substitution may be limited to electrodes that already exhibit homogeneous electrochemical surface energy, e.g. single crystal, glassy, or pre-polished Al anode. The aluminium compounds may be stable compounds, such as AlOₓ (aluminium oxide), where 2<x<4 and 0<y<5, and their combinations, that allow Al³⁺ transport and do not consume the complementary aluminium anions, such as AlCl₄⁻ (tetrachloroaluminate) or Al₂Cl₇⁻ (heptachlorodialuminate) anions. Conformal deposition may be achieved by self-limiting ALD or MLD. Inhomogeneous layers are detrimental as they promote preferential plating and stripping that may lead to fractures and dendrites formation.

Similarly, the cathode-electrolyte interface may be provided by a passivation coating comprising an inorganic aluminium compound selected from AlPₓO_{y} (aluminium phosphate), AlMoₓO_{y} (aluminium molybdate), AlWₓO_{y} (aluminium tungstate), AlVₓO_{y} (aluminium vanadate), AlOₓ (aluminium oxide), where 2<x<4 and 0<y<5, and combinations thereof, or an organic Al complex (e.g. Al-hydroxyquinoline, Al-acetylacetone, and Al-diketone). These Al compounds may be deposited by non-self-limiting vapour deposition, such as atomic layer deposition (ALD), molecular layer deposition (MLD), chemical vapour deposition (CVD) thermal evaporation, and e-beam evaporation, or by preferential electrodeposition using high pulse DC or asymmetric AC electrodeposition.

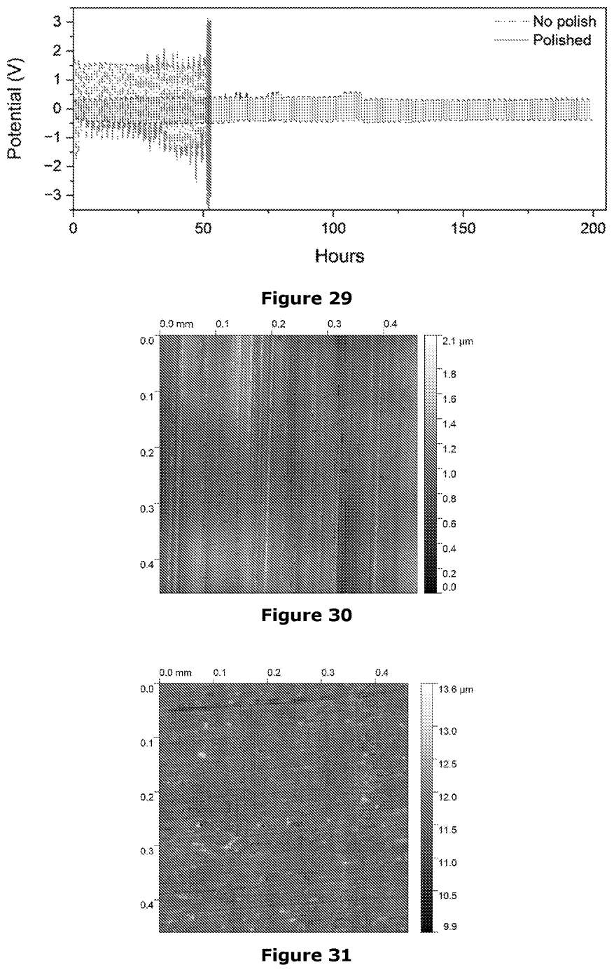

The anode may be polished to enhance cycling performance, lengthen its lifetime, and reduce dendrite formation. Electropolishing or mechanical polishing processes may be used. Electropolishing may be preferred as it may be highly selective for the most electrochemically active sites on the anode and can achieve a sub-100 nm surface finish. FIGS. 29-32 represent experimental data of galvanostatic cycling performance and lifetime of an Al anode that has been polished mechanically. The data show that after 300 cycles, and even after 1300 cycles, the cycling performance of the anode is not substantially diminished. In contrast, FIGS. 35 and 36 show the results obtained using an unpolished Al anode in a cycle life study. The unpolished anode exhibits unstable behaviour during galvanostatic charge and discharge. In FIG. 36, a comparison between the voltage reading in the galvanostatic charge-discharge graph of the polished anode is compared to the corresponding graph of the unpolished anode under the same conditions (current density of 0.0025 mA/cm²). The graph shows that the unpolished anode has a consistently higher voltage than the polished anode.

Polishing of the layered cathode may not be necessary as the main ion injection/extraction mechanisms are intercalation/deintercalation, alloying/dealloying, or conversion/deconversion, rather than plating/stripping, and as a result, dendrite formation is less likely to occur.

The invention will now be described in further detail with reference to the following non-limiting examples.

### EXAMPLES

### Example 1: Synthesis of Liquid Electrolyte

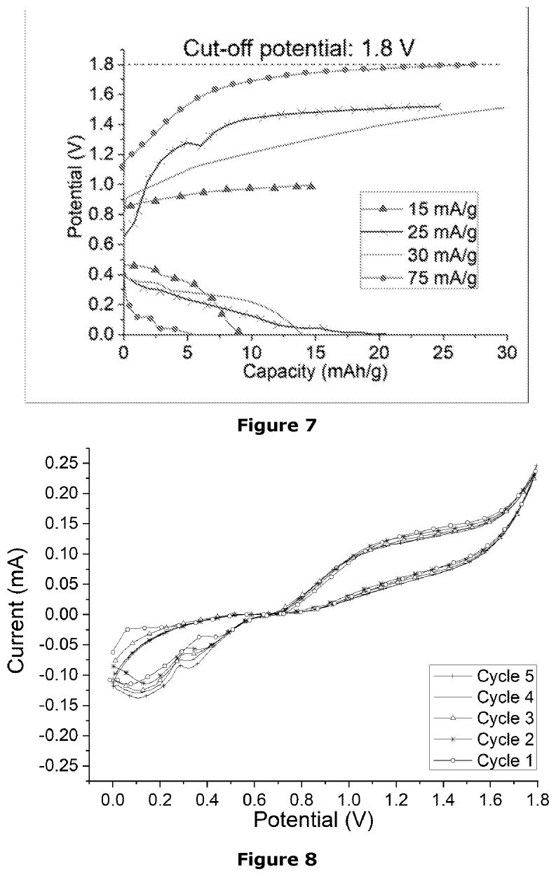

Aluminium salt and urea derivative were mixed at a molar ratio of 1.3:1 and stirred for 1hour at 50° C. to form an electrolyte. The liquid exhibited tinted yellow. Al foil was added to the electrolyte and further vacuumed to remove impurity gas according to the procedure illustrated in FIG. 7. The liquid was stirred for up to 72 hours at 50° C. The liquid exhibited tinted grey. The aluminium containing ions are confirmed by Raman spectroscopy, as shown in FIG. 6.

### Example 2: Cathode Active Material Manufacturing by Magnetron Sputtering

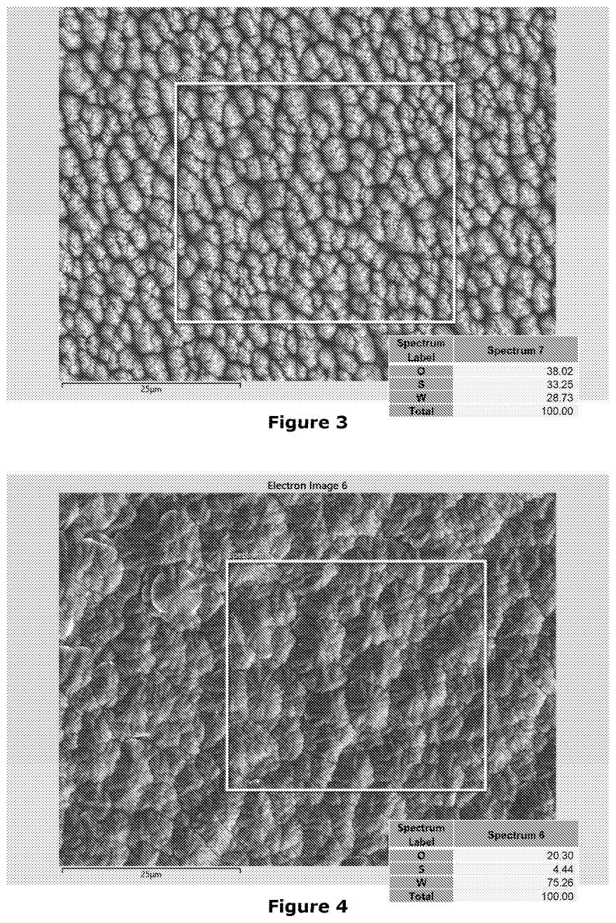

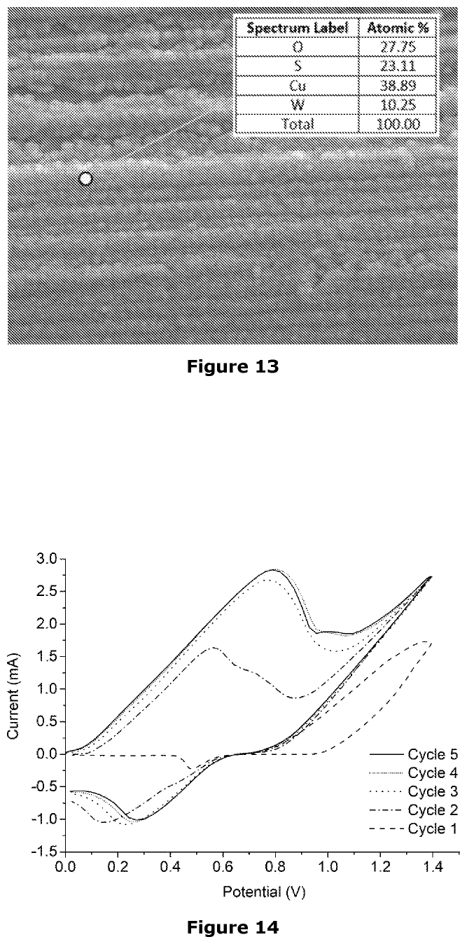

(1) The metal current collectors were cleaned with acetone and IPA for polishing. Thereafter, they were wet-polished using IPA; first by p800 SIC paper and finished with p1200 SiC paper prior to cleaning.
(2) Preparation of metal current collector by cleaning using acetone and isopropanol.
(3) Magnetron sputtering to be run by selecting parameters such as deposition time, deposition pressure, gas, distance between target and substrate (metal current collector), power density.
(4) Final composition, microstructure, Raman spectrum, and X-ray diffraction data are shown in FIG. 1, FIG. 2, FIG. 3, FIG. 4, and FIG. 13.

### Example 3: Cathode Active Material Synthesis and Deposition by Doctor-Blading

(1) Preparation of metal current collector by cleaning using acetone and isopropanol.
(2) Synthesise slurry of WS₂ (active material), PVDF (binder), and carbon black (CB) (for electric conductivity improvement) in a mass ratio of WS₂:PVDF:CB of 8:1:1. Dimethyl Sulfoxide (DMSO) was used as a solvent.
(3) WS₂ was mixed in 1.5 ml DMSO and homogenised for 20 seconds, for 10 times.
(4) In the homogenised WS₂ in DMSO, CB and PVDF were added and magnetically stirred at 50 degree C. with the addition of 1.5 ml DMSO for 3 hours until homogeneous viscous mixture is formed.
(5) Placed in a hollow mould on the metal substrate. Poured onto prepared current collector with the mould placed on the top and doctor blade to ensure the thickness of the slurry was uniform across the current collector.
(6) Placed the current collector with deposited slurry WS₂ coating into Vacuum oven and vacuum dry for 18 hours for complete removal of solvent.
(7) The mixture was drop-casted onto metal substrate and vacuum dried at 0% relative humidity, at 30 degree C. for 18 hours for complete removal of the solvent.
(8) The scanning electron micrograph of the slurry is given in FIG. 5.
(9) Layer by layer deposition can be done after complete drying of the slurry coating.
(10) Porosity and transparency of coating can be manipulated by changing relative humidity and substrate temperature at the drying process.

### Example 4: A Liquid Electrolyte Cell Comprising a Graphite on Copper Cathode, AlCl₃-thiourea (Molar Ratio=1.3:1) Liquid Electrolyte, and Aluminium Foil Anode

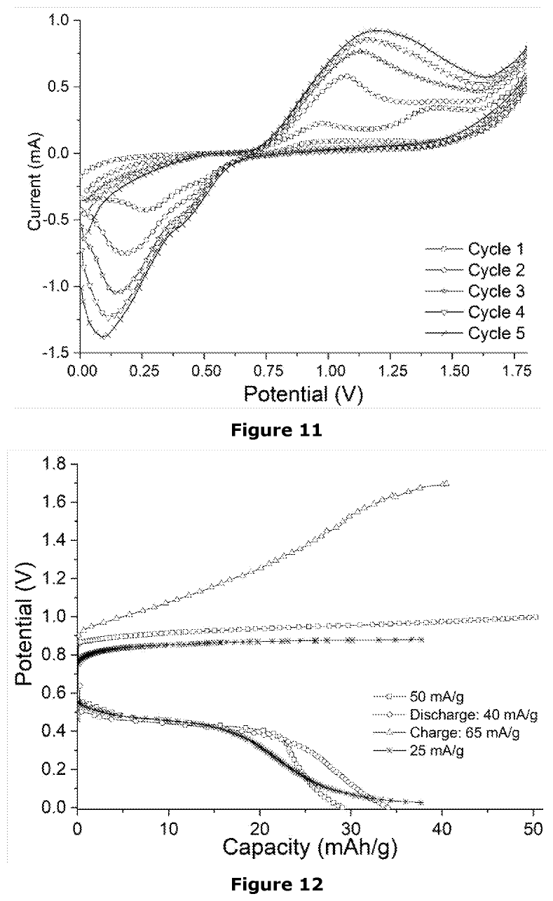

(1) The electrolyte was prepared as described in Example 1.
(2) Aluminium foil was prepared and cleaned using alcohol followed by drying in the air as the negative electrode of aluminium battery.
(3) Cathode active material was cut into desired size as positive electrode.
(4) The electrolyte prepared in step 1 was used as an electrolyte, and electrodes from step 2 and 3 used as negative and positive electrodes, respectively.
(5) Aluminium-ion battery was compared under condition of 1 C galvanostatic/dynamic charge-discharge, as shown in FIG. 12. It can be seen that specific capacity was 25 mAh/g, 34 mAh/g and 29 mAh/g at current density of 25 mA/g, 40/65 mA/g, and 50 mA/g, respectively. The electrolyte assembled battery was scanned with cyclic voltammetry (FIG. 11). At a scan rate of 0.5 mV/s, the cut-off voltage was used to determine the correspondence between oxidation peak and reduction peak, and the upper limit of the cut-off voltage determined. The value was 1.7 V.

### Example 5: A Cell Comprising a WS₂ and WO₃ Cathode on Cu Current Collector, Liquid Electrolyte, and Al Anode

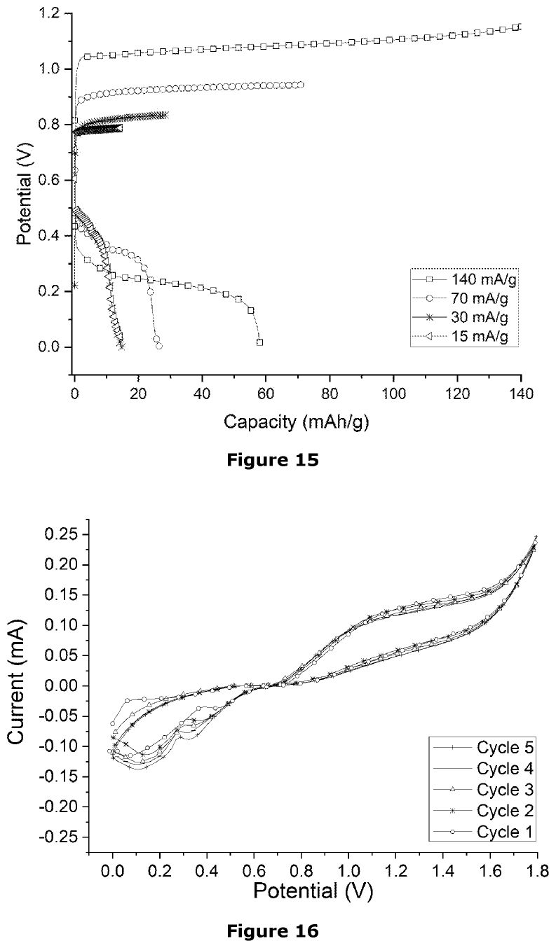

(1) The electrolyte was prepared according to Example 1.
(2) Aluminium foil was prepared and cleaned using alcohol followed by drying in the air as the negative electrode of the aluminium battery.
(3) Cathode active material was prepared as the positive electrode by magnetron sputtering (as shown in FIG. 13).
(4) The electrolytes prepared in step 1 were used as the electrolyte, and electrodes prepared in steps 2 and 3 were used as negative and positive electrodes, respectively.
(5) Aluminium-ion battery was compared under condition of 1 C galvanostatic/dynamic charge-discharge, as shown in FIG. 15. It can be seen that specific capacity was 15 mAh/g, 15.2 mAh/g, 26.5 mAh/g, and 58.1 mAh/g at current density of 15 mA/g, 30 mA/g, 70 mA/g, and 140 mA/g, respectively. The electrolyte assembled battery was scanned with cyclic voltammetry (see FIG. 14). At a scan rate of 0.5 mV/s, the cut-off voltage was used to determine the correspondence between oxidation peak and reduction peak, and the upper limit of the cut-off voltage determined. The value was 1.4 V.

### Example 6: A Cell Comprising a WS2 and WO3 Cathode, AlCl₃-thiourea (MR=1.3:1) Liquid Electrolyte on Ni Current Collector, and Al Anode

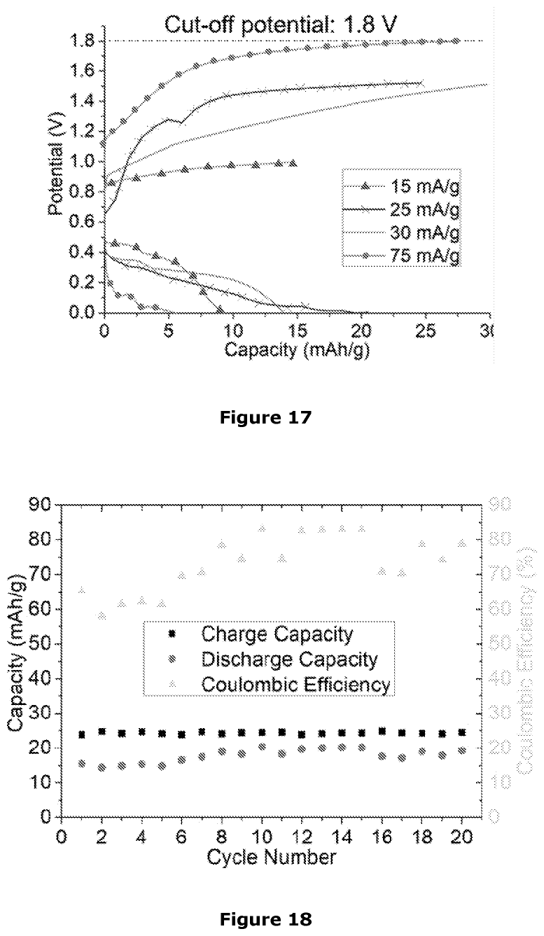

(1) The electrolyte was prepared as described in Example 1.
(2) Aluminium foil was prepared and cleaned using alcohol followed by drying in the air as the negative electrode of aluminium battery.
(3) Cathode active material was prepared as positive electrode by magnetron sputtering (see FIG. 13).
(4) The electrolytes prepared in step 1 were used as the electrolyte, and electrodes prepared in step 2 and 3 used as negative and positive electrodes, respectively.
(5) Aluminium-ion battery was compared under condition of 1 C galvanostatic/dynamic charge-discharge, as shown in FIG. 17. It can be seen that specific capacity was 10 mAh/g, 20 mAh/g, 14 mAh/g, and 6 mAh/g at current density of 15, mA/g, 25 mA/g, 30 mA/g, and 75 mA/g, respectively (FIG. 17). At current density of 25 mA/g, the battery retained the charge for 20 cycles (FIG. 18). The electrolyte assembled battery was scanned with cyclic voltammetry (FIG. 16). At a scan rate of 0.5 mV/s, the cut-off voltage were used to determine the correspondence between oxidation peak and reduction peak, and the upper limit of the cut-off voltage determined. The value was 1.8 V.

### Example 7: Solid-State Symmetric Battery: Anode and Cathode (Al foil, 99.99%), Electrolyte: AlCl₃ Hydrate+PEO/PEG+Urea Derivatives

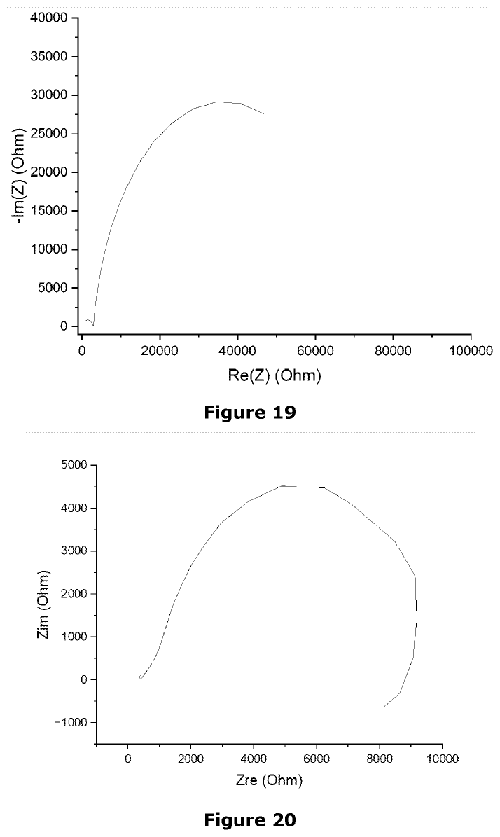

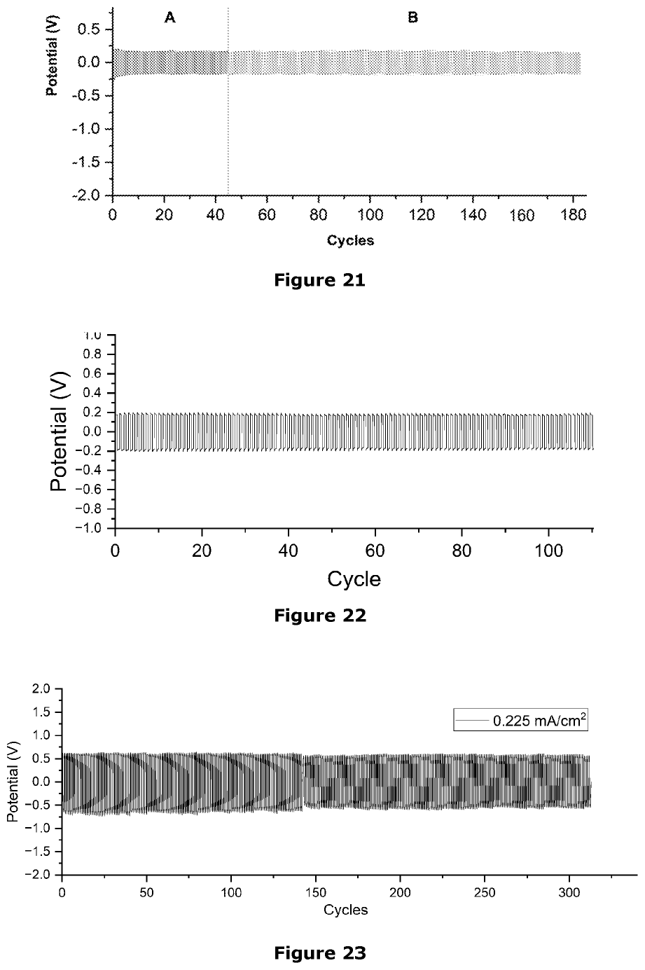

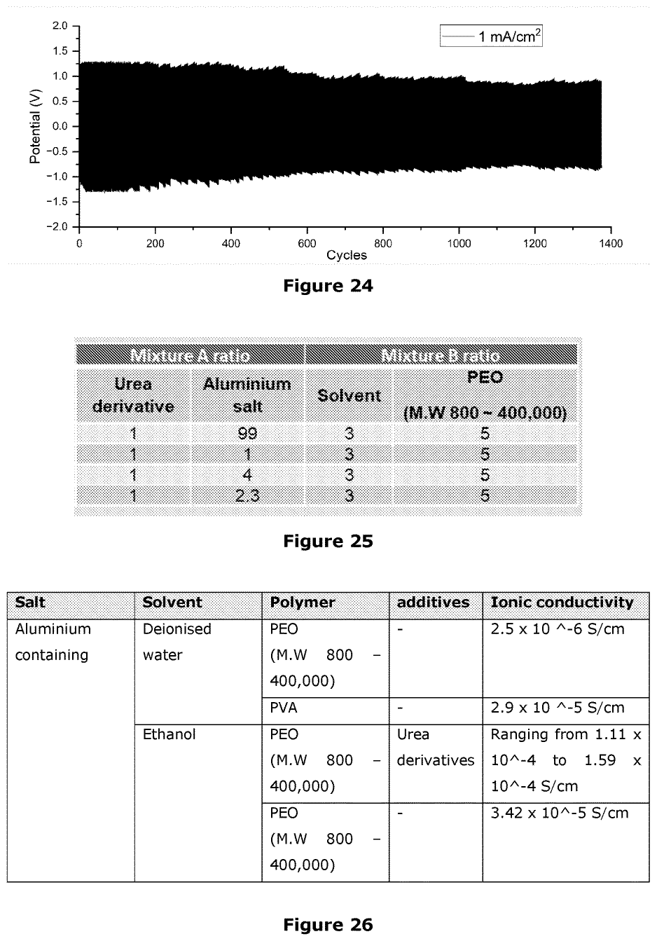

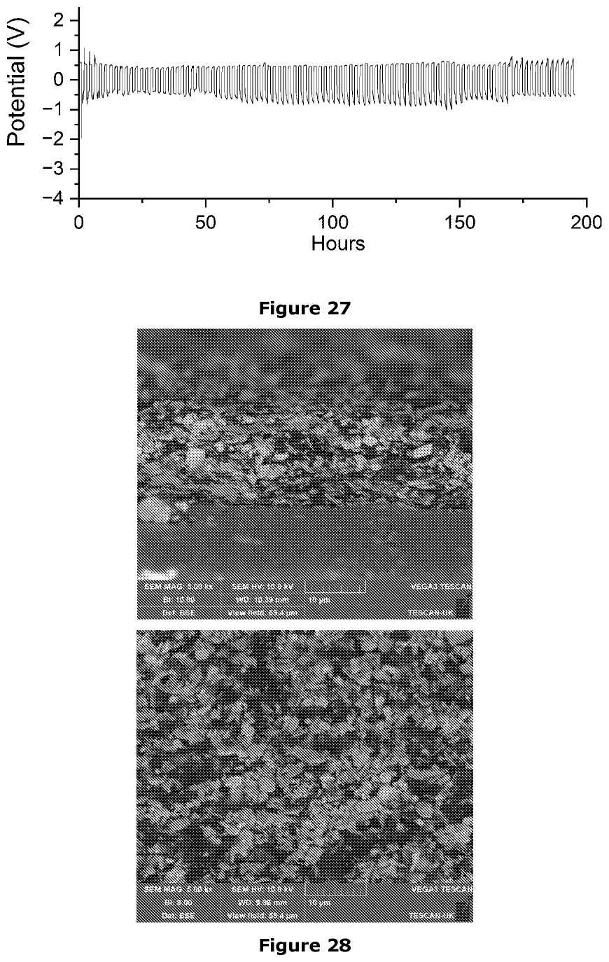

(1) The aluminium salt was dissolved in solvent according to the ratio shown in FIG. 25 and stirred for 2 hours at 70° C. to obtain homogeneous solution.
(2) Polymers according to FIG. 25 were prepared and melted at 70° C. for 2 hours.
(3) The solution from step 1 and polymer from step 2 were mixed at 70° C. for 3 hours for complete removal of the solvent.
(4) The electrolyte from step 3 was cast-moulded into a mould and cured in an ambient atmosphere for 24 hours to produce free-standing solid-state electrolyte.
(5) Aluminium electrodes were prepared, washed with alcohol with sonification and dried in the air.
(6) A symmetrical cell was assembled using solid electrolyte from step 4 and electrodes from 5. The solid electrolyte was sandwiched between aluminium electrodes, ensuring close contact between the electrodes and the electrolyte by applying pressure. The result of electrochemical impedance spectroscopy to identify the ionic conductivity using frequency from 0.1 Hertz to 1 million Hertz after an activation of electrolyte is shown in FIG. 19. The activation process uses cylic voltammetry by applying a voltage from −1.4 V to +1.4 V at a scan rate of 2.5 mV/s for 5 cycles. The complete removal of solvent was verified using electrochemical impedance spectrum (EIS). With the presence of solvent, EIS of the solid electrolyte exhibits a negative inductance (FIG. 19) unlike the EIS obtained after the complete removal of solvent (FIG. 20).

### Example 8: Solid-State Symmetric Battery: Anode and Cathode (Al foil, 99.99%), Solid State Electrolyte: AlCl₃ Hydrate+PEO/PEG+Urea Derivatives. The Aluminium Salt Was Dissolved in Solvent According to the Ratio Shown in FIG. 33 and Stirred for 1 hour at 60° C. to Obtain Homogeneous Solution

(1) Polymer (PVA, FIG. 25 and FIG. 26) were weighed and mixed with a solvent at 85° C. for 6 hours.
(2) The solutions from step 1 and step 2 were mixed at 85° C. for 2 hours. The mixture was removed from the heat and was left to stand at ambient temperature for 16 hours to remove bubbles presenting in the electrolyte.
(3) The electrolyte from step 3 was casted and cured for 24 hours to form solid electrolyte. The final thickness varies from 50 μm to 100 μm.
(4) Aluminium electrodes were prepared, washed with alcohol with sonification and dried in the air.
(5) A symmetrical cell was assembled using solid electrolyte from step 4 and electrodes from 5 in a solid-state electrolyte cell that comprises of the solid-state electrolyte sandwiched by two aluminium electrodes. The result of ionic conductivity to identify the ionic conductivity using frequency from 0.1 Hertz to 1 million Hertz after an activation of electrolyte. The activation was performed by using a cyclic voltammetry from −1.4 V to +1.4 V at a scan rate of 2.5 mV/s for 5 cycles.

### Example 9: Anode Cycle Life Study With Symmetric Cell=Aluminium Foil/AlCl₃-thiourea (MR=1.3:1)+3 Layers of Glass Fibre Separator/Aluminium Foil

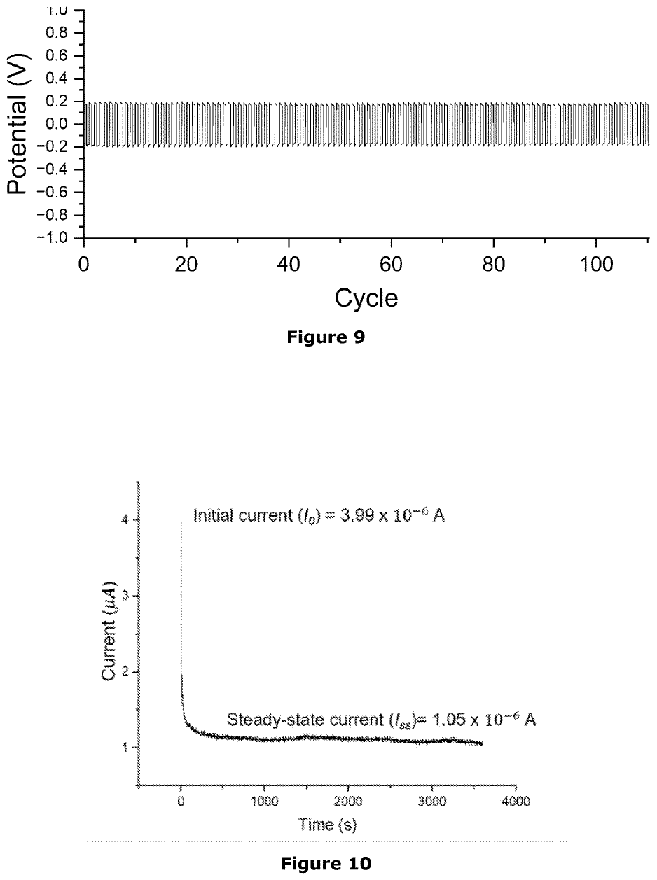

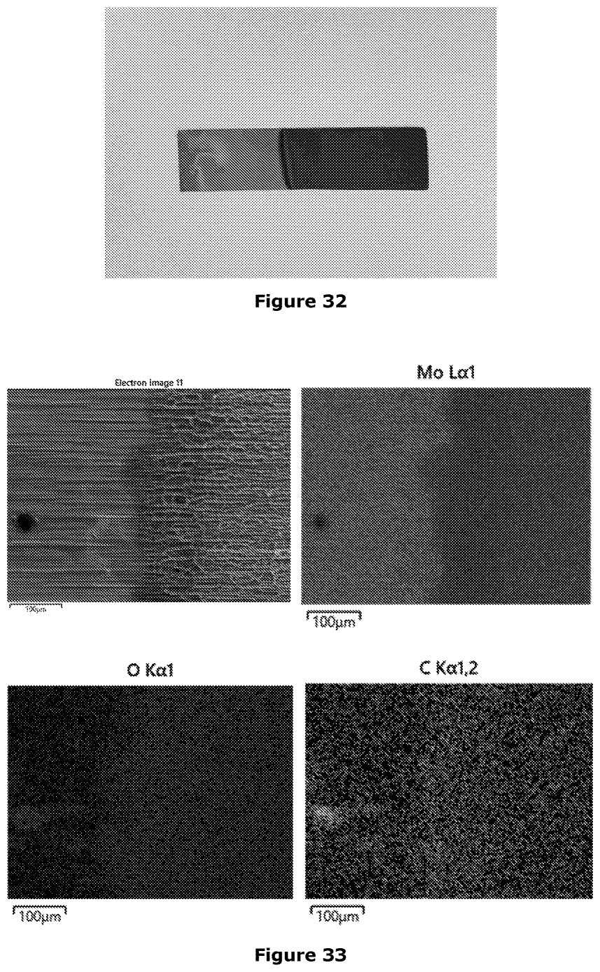

(1) The electrolyte was prepared as described in Example 1.
(2) The surface of aluminium electrodes was prepared followed by cleaning using alcohol or polished followed by cleaning using alcohol.
(3) The separator was sandwiched between the electrodes of Step 2, assembled as a symmetric cell and soaked in liquid electrolyte. The assembled symmetric cell comprises of two aluminium electrodes sandwiching 3 layers of glass fibre separator which are fully soaked in the electrolyte.
(4) The cell was fully soaked while soaking for up to 72 hours in the liquid electrolyte.
(5) Aluminium-ion battery with symmetric configuration was assessed under various current densities with different durations of cycle, using galvanostatic charge-discharge to study aluminium plating-stripping behaviour. The results are illustrated in FIG. 8. FIG. 9 shows the cycle life of the anode under 1 C and 2 C at current density of 0.0025 mA/cm\hat{ }2 galvanostatic and dynamic charge-discharge conditions. The anode survived more than in total of 1796 cycles and showed stable behaviour at current density of 0.0025 mA/cm\hat{ }2 (FIGS. 29, 180 cycles), 0.005 mA/cm\hat{ }2 (FIGS. 30, 110 cycles), 0.225 mA/cm\hat{ }2 (FIGS. 31, 131 cycles), 1 mA/cm\hat{ }2 (FIGS. 32, 1375 cycles) at 60 degree C., without failing.

### Example 10: Synthesis of Liquid Aluminium Electrolyte Using an Organic Solvent

(1) The anhydrous aluminium chloride (AlCl₃) was dried in a vacuum oven prior to mixing with propylene carbonate (PC).
(2) The dried AlCl₃ was slowly added to PC while keeping temperature of the solution below 70 degrees C. and stirring at 250 revolution per minute in a nitrogen-filled glove box or in dry air for 24 hours to form a homogeneous electrolyte.
(3) The molar concentration of final electrolyte was 1 M and exhibited brownish black solution.

### Example 11: A Study of Charge Transfer Resistance Using Organic Aluminium Electrolyte

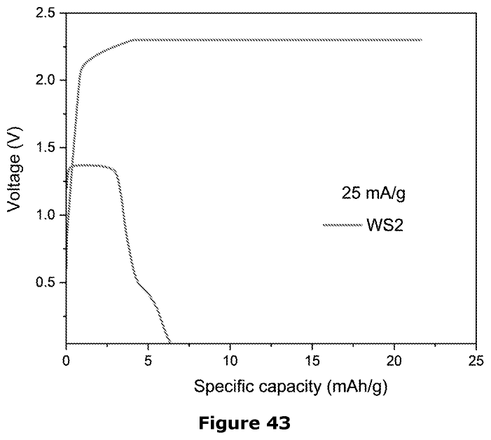

(1) The as-received aluminium foil with the surface shown in FIG. 30 was mechanically polished to provide the surface as shown in FIG. 31. Firstly, the foil was cleaned with acetone and isopropanol (IPA). The mechanical polishing was undertaken by hand using SiC paper having various grits of either p1000, p2500 or p4000, for at least 3 minutes after which it was again cleaned with acetone and isopropanol and left to dry at ambient room temperature in the air.
(2) Electrochemical impedance spectroscopy (EIS) measurements were undertaken in a liquid electrolyte prepared by a method illustrated in Example 10.
(3) The EIS set up comprised a Pt counter electrode and the mechanically polished aluminium foil as the other electrode connected to a potentiostat (VersaSTAT4). The frequency settings ranged between 1 M Hz to 0.1 Hz and root mean square (RMS) at an amplitude of 25 mV. A DC Bias potential (vs Open circuit potential) of 0.2 V was applied during EIS experiments. All measurements were conducted 3 times per sample. FIG. 43 summarises the measured data from the modified aluminium foils which have either been mechanically polished, chemically etched or electrochemically etched.

### Example 12: Cathode Active Material Synthesis and Deposition by Doctor-Blading

(1) Preparation of metal current collector by cleaning using acetone and isopropanol.
(2) Synthesise slurry of WS₂ (active material), PVDF (binder), and carbon black (CB) (for electric conductivity improvement) in a mass ratio of WS₂:PVDF:CB of 8:1:1 or 7:1.5:1.5, and NMP (1-methyl-2-pyrrolidone) was used as a solvent.
(3) WS₂ and CB were mixed in NMP and homogenised for 60 seconds, for 10 times at 25,000 rpm.
(4) In the homogenised dispersion of WS2 and CB in NMP, PVDF was added and homogenised for 2 minutes with addition of NMP until homogeneous viscous mixture is formed.
(5) Placed a hollow mould on the metal substrate. Poured onto the prepared current collector with the mould placed on the top and doctor blade to ensure the thickness of the slurry is uniform across the current collector. Upon the completion of drying of solvent, the coating was pressed.
(6) Placed the current collector with deposited slurry WS₂ coating into the vacuum oven and vacuum dried for 24 hours at 80 degrees C. or 120 degree C. at 0% relative humidity for complete removal of solvent.
(7) Layer-by-layer deposition can be done after the complete drying of the slurry coating.
(8) The scanning electron micrograph of the slurry is given in FIG. 28.

### Example 13: Anode Cycle Life Study in Organic Aluminium With Symmetrical Cell=Aluminium Foil/1 M AlCl₃ in Propylene Carbonate+1 Layer of Glass Fibre Separator/Aluminium Foil

(1) The surface of aluminium electrodes (Al foil, 99.45%) was prepared followed by cleaning using alcohol and used as received or polished followed by cleaning using alcohol. The cleaned aluminium electrodes were left to dry at ambient temperature in the air.
(2) Aluminium organic electrolyte was prepared by the method of Example 10 and aluminium electrodes were prepared by hand polishing with p2500 SiC sandpaper.
(3) The separator was sandwiched between the electrodes of Step 1, assembled as a symmetric cell and soaked in the electrolyte.
(4) The cell was fully soaked while soaking for up to 24 hours in the liquid electrolyte.
(5) Aluminium-ion battery with symmetric configuration was assessed under various current densities with different durations of cycle, using galvanostatic charge-discharge to study aluminium plating-stripping behaviour at a current density of 0.024 mA/cm\hat{ }2 at 1 C. The results are illustrated in FIG. 29 which shows the comparison of anodes with different surface treatment. In FIG. 29, anode without polish (represented as dash-dot line) failed after 25 cycles (˜50 hours) while the symmetrical cell with polished aluminium anode's cycle life (represented as a solid line) exceeded more than 100 cycles with stable behaviour.

### Example 14: Solid-Electrolyte Symmetrical Battery: Anode and Cathode (Al Foil, 99.45%), Electrolyte: PEGDA (Polyethylene Glycol Diacrylate)+AlCl3.6H2O+Photoinitiator

(1) Al foils were prepared using the method described in Example 11.
(2) First, a solution including PEGDA and deionised water was prepared by adding PEGDA (average molecular weight=600) into deionised water and shaking using a vortexer for 1 to 2 minutes for homogeneous solution.
(3) AlCl3.6H2O was added to the solution, followed by shaking using a vortexer for 1 to 2 minutes for homogeneous solution.
(4) Photoinitiator (lithium phenyl-2,4,6-trimethylbenzoylphosphinate, or LAP) was added to the previous solution and homogenised using a vortexer for 1-2 minutes before curing to form free-standing solid electrolyte. Final concentration of AlCl3 in deionised water can range from 0 to 373.7 g/L.
(5) The electrolyte was poured into a cuvette cell. The cuvette cell was comprised of a cuvette (acted as a mould and a case of the cell), Al anode, and Al cathode. The Al anode and cathode were placed onto each end of the cuvette wall facing each other and prior to the electrolyte pouring, followed by curing under UV light at a power density of 20 mW/cm\hat{ }2 for 10 seconds per side (clear sides without the blocking of UV light through cuvette), where the electrolyte was exposed.
(6) Al anode and cathode were connected to a potentiostat (VersaStat 4), and EIS (1 M Hertz to 0.1 Hertz) and Chronoamperometry (at 10 mV for 1 hour) were conducted to identify a transference number of the electrolyte. The highest ionic conductivity achieved using this solid-state electrolyte was 3.11×10\hat{ }−5 S/cm with an electrolyte synthesised using 0.8:1.5 (PEGDA:AlCl3) molar ratio.

### Example 15: Thermal Curing of Polymer Electrolyte Comprising PEGDA and Anhydrous AlCl3

(1) Drying anhydrous AlCl3 was done at 80 degrees C. in a vacuum oven prior to synthesis.
(2) PEGDA was mixed with the dried anhydrous Al salt to create 1 M AlCl3 in PEGDA.
(3) 1 M AlCl3 in PEGDA was deposited onto glass slides and cured using a hot plate at 200 degrees C. for 10 minutes. A free-standing polymer electrolyte was formed.
(4) The free-standing polymer electrolyte was left to cool down to room temperature.

### Example 16: Solid-Electrolyte Symmetrical Battery: Anode and Cathode (Al Foil, 99.45%), Electrolyte: PEGDA+AlCl3+Propylene Carbonate

(1) Al foils were prepared using the method described in Example 11.
(2) Drying anhydrous AlCl3 was done at 80 degrees C. in a vacuum oven prior to synthesis.
(3) A solution of 1 M AlCl3 in propylene carbonate was prepared as described in Example 10.
(4) PEGDA was added to 1 M AlCl3 in propylene carbonate, followed by shaking using vortexer for 1 to 2 minutes for homogeneous solution.
(5) Photoinitiator (lithium phenyl-2,4,6-trimethylbenzoylphosphinate, or LAP) was added to the previous solution and homogenised using a vortexer for 1-2 minutes before curing to form free-standing solid electrolyte.
(6) The electrolyte was poured into the cuvette cell (as described in Example 14), which included an Al foil anode and an Al foil cathode, and cured under UV light at a power density of 20 mW/cm\hat{ }2 for 10 seconds per side, where the electrolyte was exposed.
(7) Al anode and cathode were connected to a potentiostat (VersaStat 4), and EIS (1 M Hertz to 0.1 Hertz) was done to identify the ionic conductivity of the solid electrolyte. The highest ionic conductivity of the electrolyte was 4.75×10\hat{ }−7 S/cm with an electrolyte synthesised using 0.44:0.74 (PEGDA:AlCl3) molar ratio.

### Example 17: Anodisation of Molybdenum in Acidic Solution

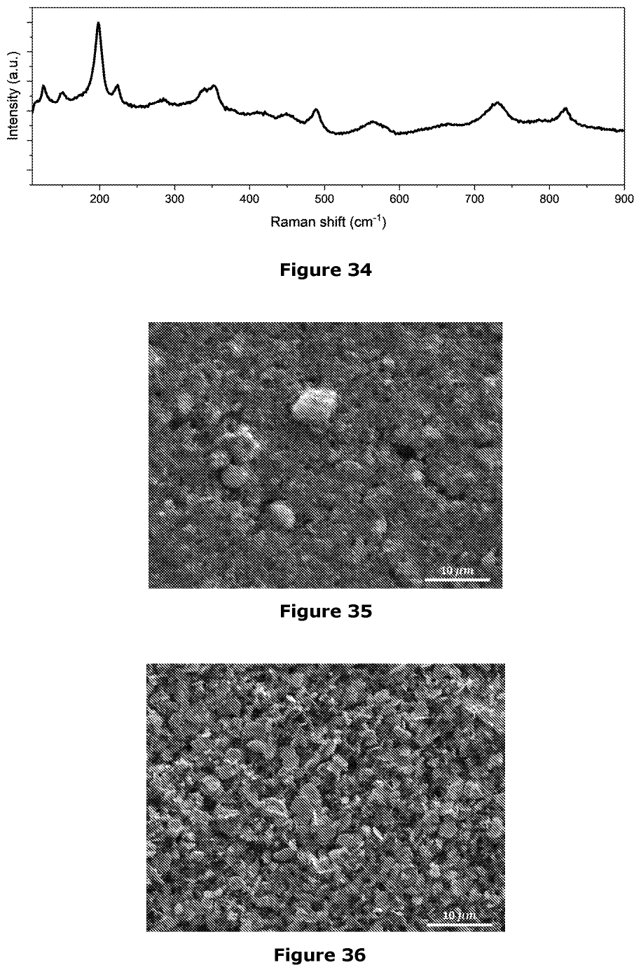

(1) Molybdenum foil was rinsed with acetone and isopropanol, followed by drying at room temperature in the air. The required area of molybdenum foil was limited by masking using non-conductive tape (Kapton tape).
(2) 0.2-2 M of citric acid solution was prepared by mixing citric acid and deionised water at room temperature for 30 minutes prior to anodisation while magnetically stirring at 250 rev/min in a glass beaker.
(3) The prepared citric acid solution was transferred in a clean beaker to anodise molybdenum foil. The solution can be used at room temperature or heated up to 70 degrees C.
(4) Molybdenum anodisation configuration is comprised of 0.2-2 M citric acid solution as electrolyte, molybdenum as anode, and platinum electrode as cathode. The electrolyte was magnetically stirred at 250 rev/min during anodisation.
(5) Anodisation proceeded by immersing Mo anode and Pt cathode in the 0.2-2 M citric acid solution while stirring at 250 rev/min. The current density of 17.5 to 35 mA/cm2 is used to anodise Mo. Duration of the anodisation can be from 60-1200 minutes.
(6) Anodised Mo was rinsed with deionised water and isopropanol and dried in air at room temperature. The anodised molybdenum foil showed a dark black colour (FIG. 32). FIG. 33 shows the scanning microscopy image of a contrast between anodised surface of Mo and non-anodised surface. FIG. 33 also shows the higher oxygen content of the anodised surface confirmed by elemental analysis mapping. FIG. 34 provides confirmation by Raman spectroscopy that the surface was anodised.

### Example 18. Cathode Active Material Synthesis With a Metal Oxide, Metal Sulphide, and Mixture Thereof, and Their Deposition by Doctor-Blading on Cathode Current Collector

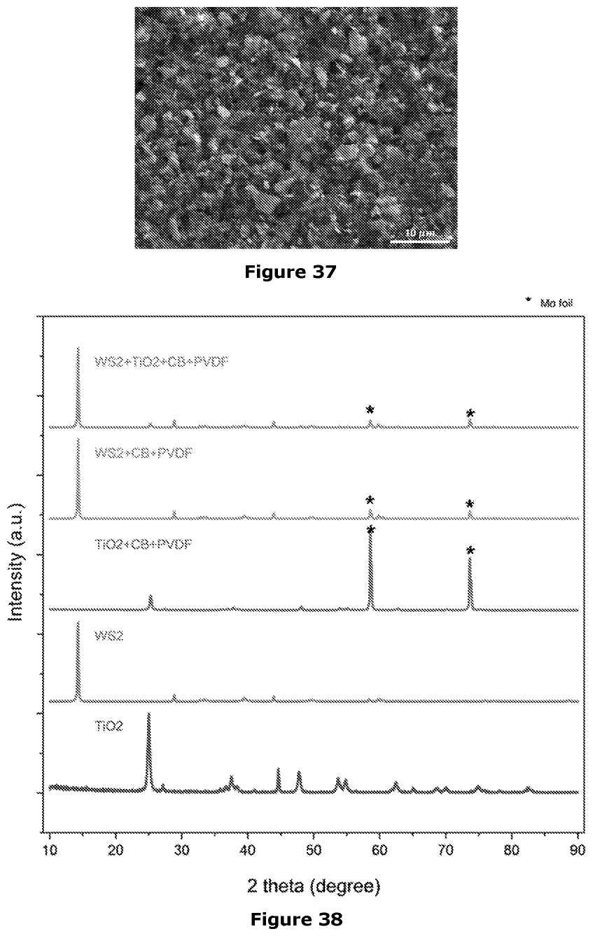

(1) Preparation of cathode metal current collector by cleaning using acetone and isopropanol.
(2) Synthesise three different slurries: 1: WS₂ (active material)+PVDF (binder)+carbon black (CB), 2: TiO2 (active material)+PVDF+CB, and 3: TiO2 and WS2 (1:1 weight ratio), PVDF, CB.
(3) Active material (or materials) and CB were mixed in NMP and homogenised for 120 seconds 10 times at 25,000 rpm.
(4) 15 wt % PVDF solution in NMP was synthesised by adding PVDF in NMP. For the homogeneous solution, the mixture was magnetically stirred at 250 rev/min for 1 hour.
(5) In the homogenised dispersion of active material (or materials) and CB in NMP, 15 wt % PVDF in NMP was added and homogenised for 2 minutes using a homogeniser at 25,000 rpm until homogeneous viscous mixture was formed. The final mass ratio of active material:PVDF:CB was 7:1.5:1.5.
(6) Place a hollow mould on the metal substrate. Pour onto the prepared current collector with the mould placed on the top and doctor blade to ensure the thickness of the slurry is uniform across the current collector.
(7) Place the current collector with the deposited slurry coating into the vacuum oven and vacuum dry for 24 hours at 80 degrees C. or 120 degree C. for 4 hours at 0% relative humidity for complete removal of solvent.
(8) Layer-by-layer deposition can be done after the complete drying of the slurry coating. Upon the drying of the solvent on slurry coating, coating is pressed using a press.
(9) The scanning electron micrographs of the slurry are given in FIG. 35 (TiO₂+PVDF+carbon black), FIG. 36 (WS₂+PVDF+carbon black), and FIG. 37 (WS₂+TiO₂+PVDF+carbon black). The X-ray diffractions of these cathode materials are given in FIG. 38.

### Example 19: Liquid Electrolyte Batteries: Cathode (a: WS2+CB+PVDF Slurry, b: TiO2+CB+PVDF, c: WS₂+TiO2+CB+PVDF) on Mo Cathode Current Collector, Anode (Al Foil, 99.45%, 25 Micron Thick), Electrolyte (1 M AlCl₃ in Propylene Carbonate Liquid Electrolyte

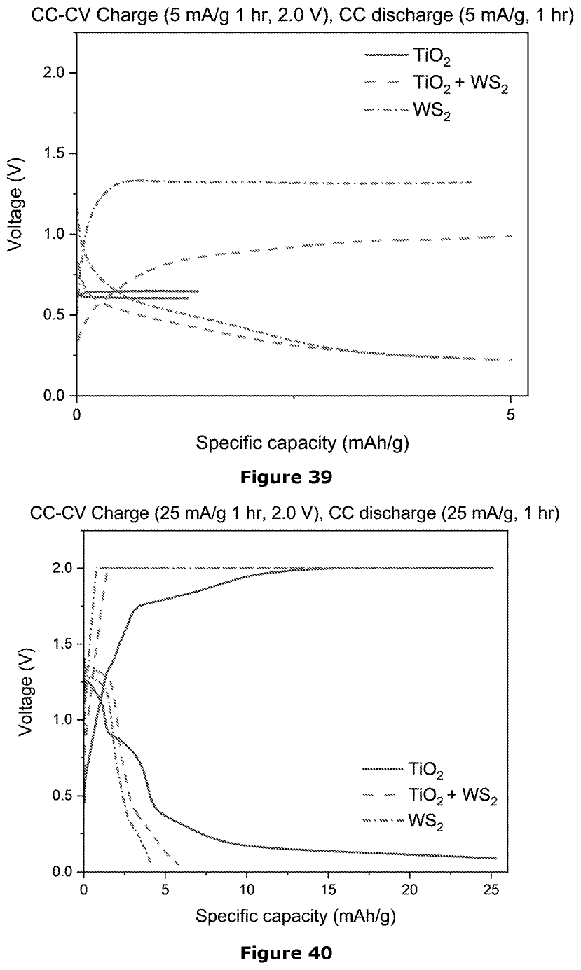

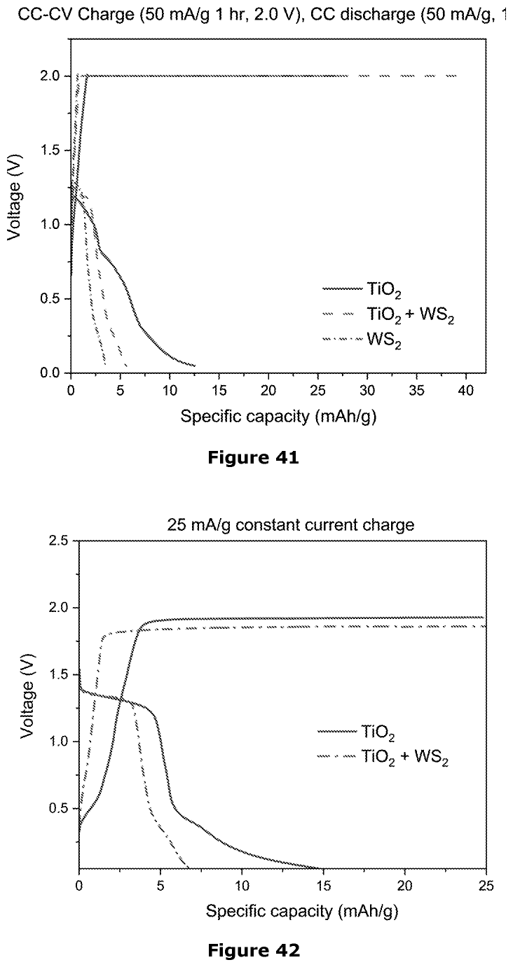

(1) Prepare aluminium foil by wet polishing with p2500 SiC paper and clean using alcohols followed by drying in the air as the negative electrode of aluminium battery.
(2) The electrolyte was prepared according to Example 10.
(3) Cathode was prepared as described in Example 18.
(4) Cathode was dried in a vacuum oven at 120 degree C. for 4 hours prior to the cell assembly.
(5) Aluminium-ion batteries were assembled using H-cell configuration.
(6) Aluminium-ion battery was compared under the condition of 1-hour CC-CV charge 1-hour-CC discharge, as shown in FIG. 39, FIG. 40, and FIG. 41. During CC-CV charge, charging voltage was set to 2.0 V or set to 2.3 V while current densities of 5 mA/g, 25 mA/g and 50 mA/g were used.
(7) At charging specific capacity of 5 mAh/g (FIG. 39) while CC-CV charging at 2.0 V, batteries showed specific capacity of 1.3 mAh/g, 4.5 mAh/g, and 4.9 mAh/g At charging specific capacity of 25 mAh/g (FIG. 42) using constant current charge, the batteries showed specific capacity of 14.8 mAh/g, and 6.8 mAh/g, for TiO2+CB+PVDF, and TiO2+WS2+CB+PVDF, respectively.
(8) At charging specific capacity of 25 mAh/g (FIG. 43) while CC-CV charging at 2.3 V, the battery with WS2+CB+PVDF cathode showed the specific capacity of 6.3 mAh/g.

The results as illustrated in FIGS. 39-43 show that the combination of MX₂ and M′O_{z} produced the highest overall capacity by comparison with either MX₂ or M′O_{z} alone (MX₂ only is represented by dash-dot throughout FIG. 39-43, while M′O_{z} only is represented by solid line throughout FIG. 39-43 . . . ). However, the MX₂ produced the highest overall energy density. However, for fast charging/discharging with higher current density, M′Oz alone may be preferred as it provides the highest overall capacity compared to either MX₂ or MX₂+M′O_{z}.

### Example 20: Cathode Current Collector Study for Selection of Suitable Current Collector in 1 M AlCl3 in Propylene Carbonate Liquid Electrolyte

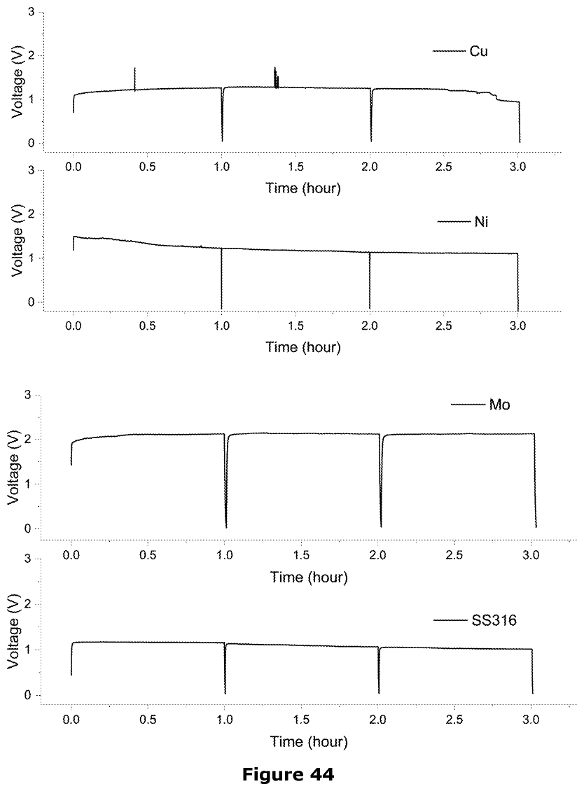

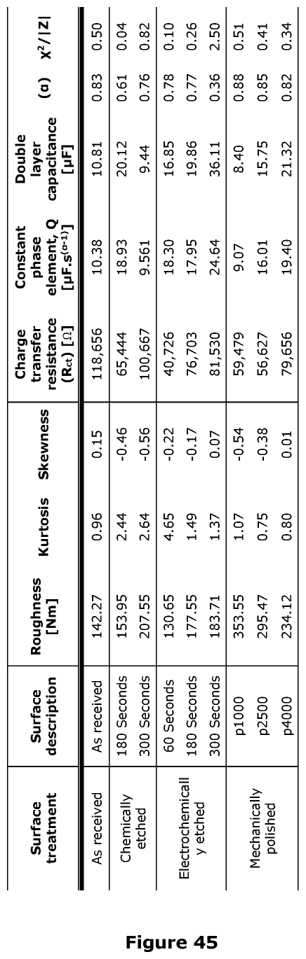

(1) The electrolyte to be prepared as Example 10 describes. Stainless steel 316 (SS316), copper, nickel, molybdenum, and aluminium are cleaned with acetone and isopropanol, followed by drying in the air at room temperature.
(2) Aluminium foil is used as anode, and stainless steel 316 (SS316), copper, nickel, and molybdenum foil are used as a cathode current collector. 1 M aluminium chloride in propylene carbonate electrolyte illustrated in Example 10 is used as electrolyte.
(3) The electrolyte was prepared according to Example 10.
(4) Four electrochemical cells were assembled using SS316, copper, nickel, and molybdenum foil were used as a cathode current collector. Each electrochemical cell comprised an Al anode, metal cathode current collector, and 1 M aluminium chloride electrolyte.
(5) The cells were constant current charged and discharged for an hour using 0.01 mA/cm\hat{ }2. The results of charge-discharge are illustrated in FIG. 44 and show that the highest potential was achieved with a Mo current collector.

It would be appreciated that the process and apparatus of the invention are capable of being implemented in a variety of ways, only a few of which have been illustrated and described above.

1. A battery comprising:
an anode comprising aluminium or aluminium alloy;
a cathode comprising a transition metal dichalcogenide of the formula MX2 and a transition metal oxide of the formula M′Oz;
wherein:
O is oxygen;
M and M′ are each independently a transition metal selected from the group consisting of Ti (titanium), V (vanadium), Zr (zirconium), Nb (niobium), Mo (molybdenum), Sn (tin), Hf (hafnium), Ta (Tantalum), W (tungsten) or combinations thereof;
X is selected from S (sulphur), Se (selenium), Te (tellurium) and combinations thereof; and
z is 1, 2 or 3; and
an electrolyte comprising ionic aluminium, wherein the electrolyte is disposed between the anode and the cathode.

2. The battery according to claim 1, wherein the mass ratio of MX2:M′Oz in the cathode is from 0.1-3:3-0.1, from 0.5-1.5:1.5-0.5, or about 1:1.

3. The battery according to claim 1, wherein the electrolyte is a solid electrolyte.

4. The battery according to claim 3, wherein the electrolyte comprises polyacrylate or polymethylmethacrylate.

5. The battery according to claim 4, wherein the polymer comprises a photoinitiator.

6. The battery according to any of claim 1, wherein M and M′ are each independently selected from W, Ti and V.

7. The battery according to any of claim 1, wherein the cathode further comprises a carbonaceous material selected from the group consisting of graphene, graphene oxide, reduced graphene oxide, graphite, activated carbon, carbon black and combinations thereof, preferably wherein the carbonaceous material is present in the cathode in one or more layers.

8. The battery according to claim 7, wherein the cathode comprises (i) one or more layers of MX2 and M′Oz, and (ii) one or more layers of the carbonaceous material, optionally wherein the layers of MX2 and M′Oz are stochastic 3D structures.

9. The battery according to claim 1, wherein the cathode is deposited on a current collector comprising one or more metals selected from copper, nickel, stainless steel and molybdenum, preferably wherein the current collector comprises molybdenum.

10. The battery according to claim 1, wherein the aluminium or aluminium alloy of the anode is at least partially coated with a passivation coating.

11. The battery according to claim 10, wherein the passivation coating comprises an inorganic aluminium compound selected from the group consisting of aluminium phosphate, aluminium molybdate, aluminium tungstate, aluminium vanadate, aluminium oxide, Al-hydroxyquinoline, Al-acetylacetone, Al-diketone, and combinations thereof.

12. Use of the battery according to any one of claim 1 in a mobile electronic device, a static energy storage device, an uninterruptible power supply, a watercraft, a drone, an electric vehicle, or an aircraft.

13. A mobile electronic device, a static energy storage device, an uninterruptible power supply, a watercraft, a drone, or an electric vehicle, comprising the battery according to claim 1.

14. A method of manufacturing a battery, the method comprising:
providing an anode comprising aluminium or aluminium alloy;
providing a cathode comprising a transition metal dichalcogenide of the formula MX2 and a transition metal oxide of the formula M′Oz;
wherein:
O is oxygen;
M and M′ are each independently a transition metal selected from the group consisting of Ti (titanium), V (vanadium), Zr (zirconium), Nb (niobium), Mo (molybdenum), Sn (tin), Hf (hafnium), Ta (Tantalum), W (tungsten) or combinations thereof;
X is selected from S (sulphur), Se (selenium), Te (tellurium) and combinations thereof; and
z is 1, 2 or 3;
providing an electrolyte comprising ionic aluminium; and
disposing the electrolyte between and in electrical communication with the anode and the cathode to provide the battery.

15. The method according to claim 14, wherein the electrolyte is a solid electrolyte, preferably wherein the electrolyte comprises polyacrylate or polymethylmethacrylate.
